(19) United States
(12) Patent Application Publication
(10) Pub. No.: US 2024/0020288 A1
(43) Pub. Date: Jan. 18, 2024

(54) DATA VALIDATION DEVICE, DATA VALIDATION METHOD, AND NON-TRANSITORY COMPUTER-READABLE MEDIUM

(71) Applicant: Mitsubishi Electric Corporation, Tokyo (JP)

(72) Inventor: Daiki NAKASHIMA, Tokyo (JP)

(73) Assignee: Mitsubishi Electric Corporation, Tokyo (JP)

(21) Appl. No.: 18/372,400

(22) Filed: Sep. 25, 2023

Related U.S. Application Data
(63) Continuation of application No. PCT/JP2021/016889, filed on Apr. 28, 2021.

(51) Int. Cl. G06F 16/22

(52) U.S. Cl. CPC G06F 16/2228

(57) ABSTRACT

A data validation device (100) includes a validity determination unit (120). The validity determination unit (120) determines whether or not it is valid to register in a distributed ledger, block data that includes data corresponding to subject data, based on form information indicating a form to be followed by data corresponding to the data included in the block data to be registered in the distributed ledger.

### CROSS REFERENCE TO RELATED APPLICATION

This application is a Continuation of PCT International Application No, PCT/JP2021/016889, filed on Apr. 28, 2021, which is hereby expressly incorporated by reference into the present application.

### TECHNICAL FIELD

The present disclosure relates to a data validation device, a data validation method, and a data validation program.

### Background Art

A system that utilizes a distributed ledger represented by a blockchain has been increasing. The distributed ledger is a technology to share an operational request of the ledger between stakeholders and to implement the shared ledger between the stakeholders. The operational request is also called a transaction. In a general distributed ledger, a distributed ledger server owned by each stakeholder holds at least all of past transactions of the distributed ledger server and stakeholders relating to the distributed ledger server, so that it is possible to validate between the stakeholders, shared data that includes past data. Here, the distributed ledger server is also called a node. Therefore, the distributed ledger is effective as means of guaranteeing possibility of validation of the shared data.

When data such as history information is handled as new shared data in the distributed ledger, it is required to link data from a system, a datastore such as a database, or a physical file created manually such as Excel (registered trademark) that is out of the distributed ledger, and to take in the linked data in the distributed ledger. The out of the distributed ledger means a data area or the like that is not included in the distributed ledger. Here, in the blockchain which is a kind of distributed ledger, the out of the distributed ledger is called an off-chain. On the other hand, since out-of-distributed ledger data comes in various forms as described above, accuracy of the data may not be constant. When the out-of-distributed ledger data is registered as it is in the distributed ledger without considering the accuracy of the data, incorrect data with a contradiction such as missing or duplicated data may be registered in the distributed ledger, and the incorrect data may be shared among stakeholders who own the same distributed ledger. Therefore, when the out-of-distributed ledger data is registered in the distributed ledger, before registering the out-of-distributed ledger data, it is required to check whether or not there is any contradiction in the out-of-distributed ledger data, that is, it is required to validate the validity of the out-of-distributed ledger data.

Patent Literature 1 discloses a device that extracts inconsistent data from out-of-distributed ledger data, based on data registered in a distributed ledger.

### CITATION LIST

### Patent Literature

Patent Literature 1: JP 2020-524828 A

### SUMMARY OF INVENTION

### Technical Problem

According to the device disclosed in Patent Literature 1, inconsistent data is extracted from out-of-distributed ledger data, based on data registered in a distributed ledger, Therefore, according to Patent Literature 1, there is a problem in that a determination result of whether or not inconsistent data is included in the out-of-distributed ledger data depends on data registered in the distributed ledger.

The present disclosure aims to determine whether or not inconsistent data is included in out-of-distributed ledger data without depending on data registered in a distributed ledger.

### Solution to Problem

A data validation device that controls a distributed ledger that records electronic data according to the present disclosure includes a validity determination unit to determine whether or not it is valid to register in the distributed ledger, block data that includes data corresponding to subject data, based on form information indicating a form to be followed by data corresponding to the data included in the block data to be registered in the distributed ledger.

### Advantageous Effects of Invention

According to the present disclosure, a validity determination unit determines whether or not it is valid to register in a distributed ledger, block data that includes data corresponding to subject data, based on form information. The subject data corresponds to out-of-distributed ledger data. Further, determining whether or not it is valid to register the block data in the distributed ledger is equivalent to determining whether or not inconsistent data is included in the out-of-distributed ledger data. Furthermore, state transition information is not data registered in the distributed ledger. Therefore, according to the present disclosure, it is possible to determine whether or not the inconsistent data is included in the out-of-distributed ledger data without depending on the data registered in the distributed ledger.

### BRIEF DESCRIPTION OF DRAWINGS

FIG. 1 is a diagram illustrating a functional configuration example of a data validation system 90 according to Embodiment 1.

FIG. 2 is a diagram illustrating a hardware configuration example of the data validation system 90 according to Embodiment 1.

FIG. 3 is a diagram illustrating a software configuration example of the data validation system 90 according to Embodiment 1.

FIG. 4 is a diagram illustrating a specific example of a validation request transaction 501.

FIG. 5 is a flowchart illustrating operation of a validation consensus formation unit 110 according to Embodiment 1.

FIG. 6 is a diagram illustrating a specific example of each of a validity determination request 502 and a validity determination result 503.

FIG. 7 is a flowchart illustrating operation of a validity determination unit 120 according to Embodiment 1.

FIG. 8 is a diagram illustrating a specific example of each of a contradictory data extraction request 504 and a contradictory data extraction result 505.

FIG. 9 is a flowchart illustrating operation of a contradictory data extraction unit 130 according to Embodiment 1.

FIG. 10 is a diagram illustrating a specific example of a state transition flow.

FIG. 11 is a diagram explaining a contradictory data extraction result, and (a) is a table illustrating a specific example of off-chain data and (b) is a table illustrating a specific example of on-chain data.

FIG. 12 is a diagram illustrating a specific example of each of a registration request transaction 506 and a block 507.

FIG. 13 is a flowchart illustrating the operation of the validation consensus formation unit 110 according to Embodiment 1,

FIG. 14 is a diagram illustrating a hardware configuration example of a data validation device 100 according to Modification of Embodiment 1.

FIG. 15 is a diagram illustrating a functional configuration example of the data validation system 90 according to Embodiment 2,

FIG. 16 is a diagram illustrating a software configuration example of the data validation system 90 according to Embodiment 2.

FIG. 17 is a diagram illustrating a specific example of a validity determination result notification 508.

FIG. 18 is a flowchart illustrating the operation of the validation consensus formation unit 110 according to Embodiment 2.

FIG. 19 is a diagram illustrating a functional configuration example of the data validation system 90 according to Embodiment 3,

FIG. 20 is a diagram illustrating a software configuration example of the data validation system 90 according to Embodiment 3.

FIG. 21 is a diagram illustrating a specific example of each of a validation request transaction 509 and a block 510.

FIG. 22 is a flowchart illustrating the operation of the validation consensus formation unit 110 according to Embodiment 3.

### DESCRIPTION OF EMBODIMENTS

In the description and drawings of embodiments, the same elements and corresponding elements are denoted by the same reference sign. The description of elements denoted by the same reference sign will be suitably omitted or simplified. Arrows in the drawings mainly indicate flows of data or flows of processing. Further, “unit” may be suitably interpreted as “circuit”, “step”, “procedure”, “process”, or “circuitry”.

### Embodiment 1

The present embodiment will be described in detail below with reference to the drawings.

***Description of Configuration***

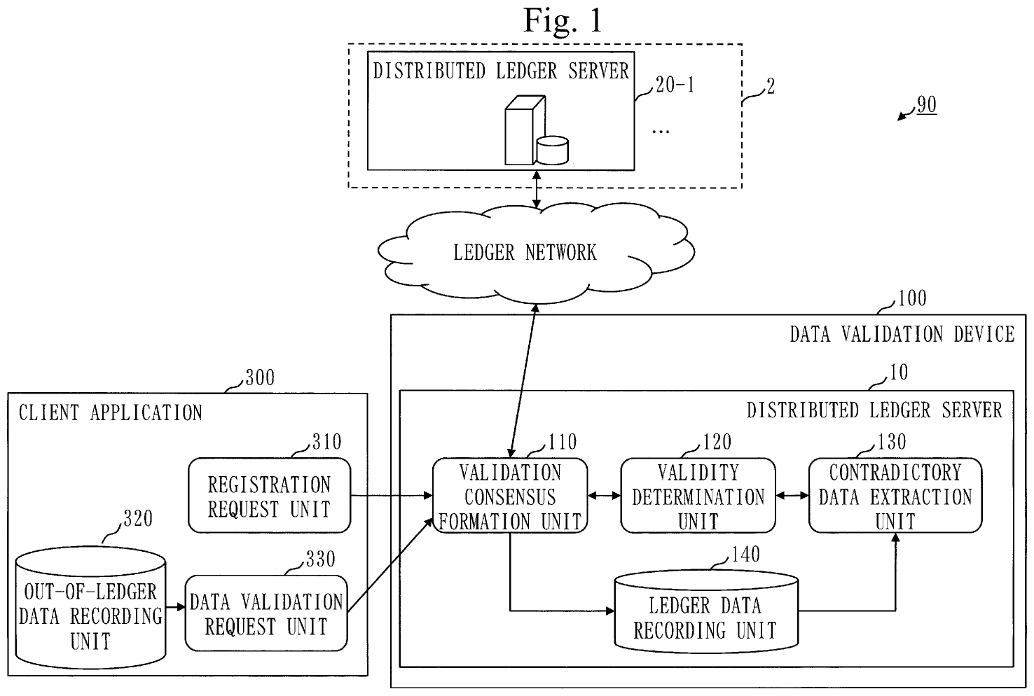

FIG. 1 illustrates a functional configuration example of a data validation system 90 according to the present embodiment. As illustrated in this drawing, the data validation system 90 includes a data validation device 100, a client application 300, and a distributed ledger server group 2.

Pieces of data held between distributed ledger servers that belong to a ledger network may differ, such as pieces of data being not properly synchronized between the distributed ledger servers that belong to the ledger network.

The data validation device 100 includes a distributed ledger server 10. The data validation device 100 is also called an out-of-distributed ledger data validity validation device. The data validation device 100 controls a distributed ledger that records electronic data. The data validation device 100 belongs to a ledger network that includes at least one distributed ledger server 20.

The distributed ledger server 10 is a device or an application, receives from a data validation request unit 330, a registration request transaction 506 which is out-of-distributed ledger data, determines the validity of the received out-of-distributed ledger data, and when the received out-of-distributed ledger data includes contradictory data, extracts the contradictory data from the out-of-distributed ledger data. The distributed ledger server 10 may register in the distributed ledger server 10, each function received from a registration request unit 310, and change each function registered in the distributed ledger server 10. The function is, as a specific example, a program. The application refers to an application program. The validity of the data is an index indicating whether or not it is valid to register the data in the distributed ledger. The registration request transaction 506 is a transaction that requests to determine the validity of the out-of-distributed ledger data, and to extract the contradictory data when the out-of-distributed ledger data includes the contradictory data. Further, the registration request transaction 506 is also called a determination/extraction process registration request transaction. The contradictory data is data that does not follow a predetermined form. The form indicates, as a specific example, a state transition, a value, or a format. The contradictory data is, as a specific example, data that does not follow a predetermined state transition, data indicating a value that differs from a predetermined value, or data that does not follow a predetermined format. The term device and the term application may have equivalent meanings.

Further, the distributed ledger server 10 receives from the data validation request unit 330, a validation request transaction 501 that includes out-of-distributed ledger data, extracts the out-of-distributed ledger data from the received validation request transaction 501, determines the validity of the extracted out-of-distributed ledger data, and extracts contradictory data from the out-of-distributed ledger data when the extracted out-of-distributed ledger data includes the contradictory data. The validation request transaction 501 is a transaction that requests to determine the validity of the data extracted from an out-of-ledger data recording unit 320 and to extract the contradictory data when the data includes the contradictory data. Further, the validation request transaction 501 is also called an out-of-distributed ledger data validation request transaction.

The distributed ledger server 10 is able to mutually communicate with each of the client application 300 and each distributed ledger server 20 included in the distributed ledger server group 2.

The client application 300 is a device or an application, and has a function of transmitting to the distributed ledger server 10, the registration request transaction 506 and the validation request transaction 501.

The distributed ledger server group 2 has one or more distributed ledger servers 20. “−1” or the like is a notation for mutually distinguishing a plurality of distributed ledger servers 20.

Each distributed ledger server 20 is a device or an application, and is connected to the distributed ledger server 10 via the ledger network. The ledger network is also called a distributed ledger network. The distributed ledger server 20 may not have the same function as that of the distributed ledger server 10.

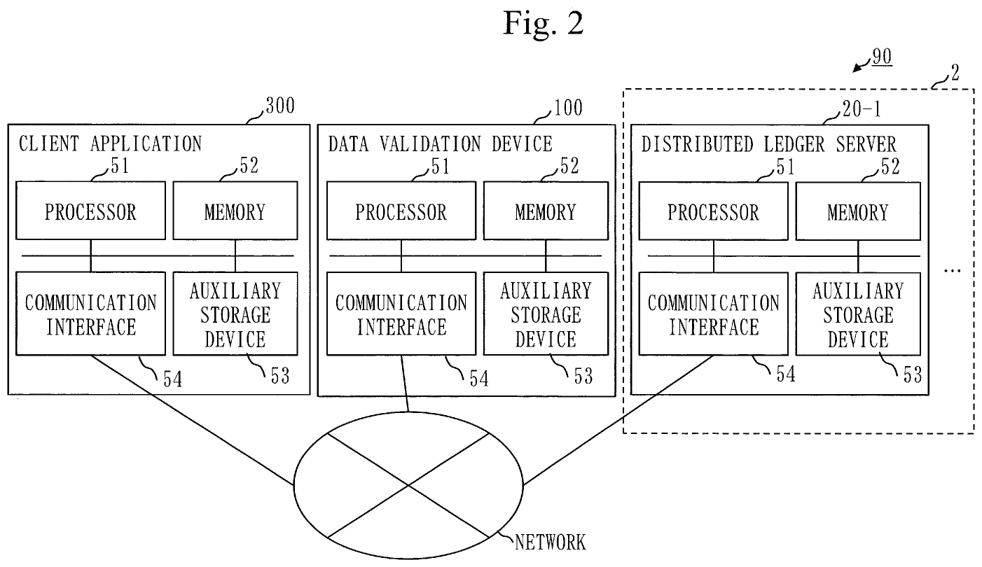

FIG. 2 illustrates a hardware configuration example of each device included in the data validation system 90. FIG. 2 illustrates a specific example in which each of the data validation device 100, the client application 300, and the distributed ledger server 20 operates in a mutually different device.

Each device is a computer that includes pieces of hardware such as a processor 51, a memory 52, an auxiliary storage device 53, and a communication interface 54. The pieces of hardware included in the computer are appropriately connected via signal lines. Each device may be configured with a plurality of computers. Each device is connected to each other via a network. Although FIG. 2 illustrates a specific example in which each device is connected to one network, the network may be divided into a plurality of networks as long as the distributed ledger server 10 is able to communicate with the client application 300 and the distributed ledger server 10 is able to communicate with the distributed ledger server 20. Further, at least a part of the distributed ledger server 10, the client application 300, and the distributed ledger server 20 may be configured with the same device. Further, the device is not limited to a physical device, and may be a device virtualized by a virtualization technology.

The processor 51 is an Integrated Circuit (IC) that performs arithmetic processing, and controls the pieces of hardware included in the computer. The processor 51 is, as a specific example, a Central Processing Unit (CPU), a. Digital Signal Processor (DSP), or a Graphics Processing Unit (GPU). Each device may include a plurality of processors as an alternative to the processor 51. The plurality of processors share the role of the processor 51.

The memory 52 is typically a volatile storage device. The memory 52 is also called a main storage memory or a main memory. The memory 52 is, as a specific example, a Random Access Memory (RAM). Data stored in the memory 52 is stored in the auxiliary storage device 53 as necessary.

The auxiliary storage device 53 is typically a non-volatile storage device. The auxiliary storage device 53 is, as a specific example, a Read Only Memory (ROM), a Hard Disk Drive (HDD), or a flash memory. Data stored in the auxiliary storage device 53 is loaded into the memory 52 as necessary.

The memory 52 may be integrally configured with the auxiliary storage device 53.

The auxiliary storage device 53 stores a data validation program. The data validation program is a program that causes the computer to implement a function of each unit included in the data validation device 100. The data validation program is loaded into the memory 52, and executed by the processor 51. The function of each unit included in the data validation device 100 is implemented by software.

The data validation program may be recorded in a computer-readable non-volatile recording medium. The non-volatile recording medium is, as a specific example, an optical disc or a flash memory. The data validation program may be provided as a program product.

Data used while executing the data validation program, data obtained by executing the data validation program, and the like are appropriately stored in a storage device. Each unit of the data validation device 100 appropriately uses the storage device. The storage device is configured with at least one of, as a specific example, the memory 52, the auxiliary storage device 53, a register in the processor 51 and a cache memory in the processor 51. Data and information may have the same meaning. The storage device may be independent of each device.

Functions of the memory 52 and the auxiliary storage device 53 may be implemented by another storage device.

The communication interface 54 is a receiver and a transmitter. The communication interface 54 is, as a specific example, a communication chip or a Network Interface Card (NIC).

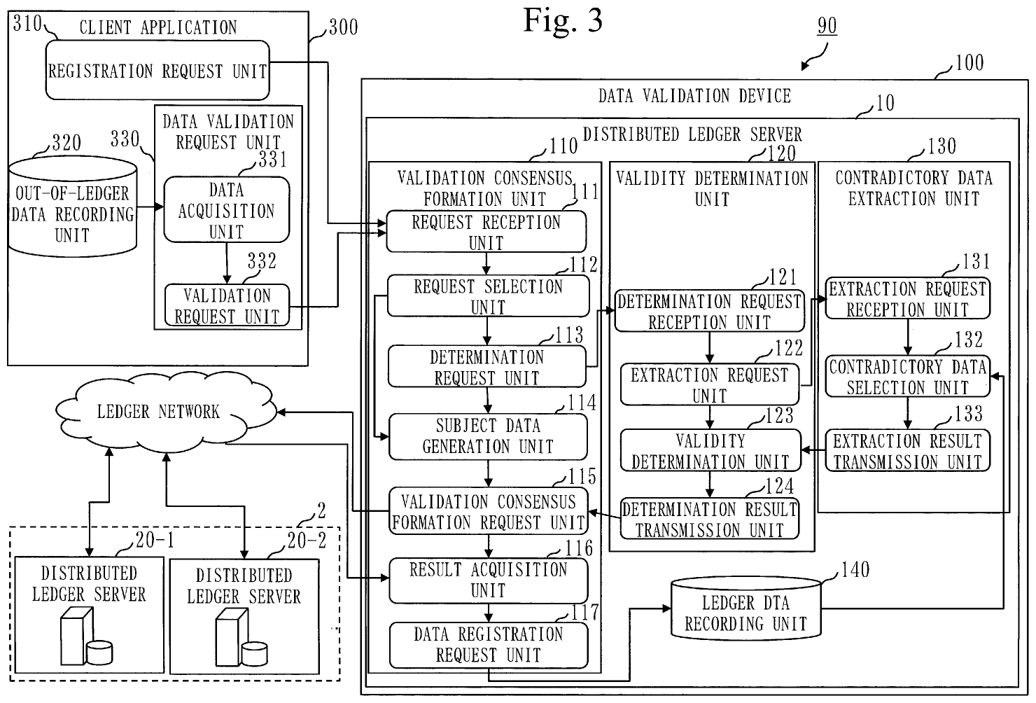

FIG. 3 illustrates a software configuration example of the data validation system 90, In FIG. 3, it is assumed to validate the validity of the out-of-distributed ledger data held by the client application 300, in the distributed ledger server 10 connected to a ledger network connected to at least one or more distributed ledger servers 20.

The distributed ledger server 10 includes a validation consensus formation unit 110, a validity determination unit 120, a contradictory data extraction unit 130, and a ledger data recording unit 140.

The validation consensus formation unit 110 includes a request reception unit 111, a request selection unit 112, a determination request unit 113, a subject data generation unit 114, a validation consensus formation request unit 115, a result acquisition unit 116, and a data registration request unit 117.

The request reception unit 111 receives from the client application 300, the registration request transaction 506 and the validation request transaction 501.

The request selection unit 112 selects a transaction received by the request reception unit 111 transfers the selected transaction to the determination request unit 113 when the selected transaction is the validation request transaction 501, and transfers the selected transaction the subject data generation unit 114 when the selected transaction is the registration request transaction 506.

The determination request unit 113 requests the validity determination unit 120 to determine the validity of the out-of-distributed ledger data.

The subject data generation unit 114 generates data subject to validation and consensus formation. Further the subject data generation unit 114 is also called a validation consensus formation subject data generation unit.

The validation consensus formation request unit 115 receives a result of determining the validity of the out-of-distributed ledger data. The validation consensus formation request unit 115 requests each distributed ledger server 20 to operate the validation and consensus formation for a block that includes a plurality of transactions. The validation consensus formation request unit 115 receives transaction data from the client application 300, and extracts subject data from the transaction data. The subject data may be at least a part of the transaction data. The transaction data may indicate a smart contract. When the transaction data indicates the smart contract, the validation consensus formation request unit 115 may request at least one of the distributed ledger servers 20 to operate the validation of block data.

The result acquisition unit 116 acquires a result of the validation and consensus formation from each distributed ledger server 20. Further, the result acquisition unit 116 is also called a validation/consensus formation result acquisition unit

The data registration request unit 117 requests the ledger data recording unit 140 to register the result of the validation and the consensus formation, and the block. Further, the data registration request unit 117 is also called a distributed ledger data registration request unit.

The validity determination unit 120 includes a determination request reception unit 121, an extraction request unit 122, a validity determination unit 123, and a determination result transmission unit 124. The validity determination unit 120 is also called an out-of-distributed ledger data validity determination unit. The validity determination unit 120 determines whether or not it is valid to register in the distributed ledger, the block data that includes data corresponding to the subject data, based on form information. The form information indicates a form to be followed by data corresponding to data included in the bock data to be registered in the distributed ledger. State transition information is a type of the form information, and is information indicating a state transition to be followed by the data corresponding to the data included in the block data to be registered in the distributed ledger. The state transition information may be recorded anywhere. The subject data is data corresponding to the data corresponding to the data included in the block data to be registered in the distributed ledger. The validity determination unit 120 may divide the subject data into units for extracting the contradictory data.

The determination request reception unit 121 receives from the validation consensus formation unit 110, data indicating a determination request.

The extraction request unit 122 request the contradictory data extraction unit 130 to extract the contradictory data.

The validity determination unit 123 determines the validity of the subject data of the determination request, based on the result of extracting the contradictory data received from the contradictory data extraction unit 130. When the contradictory data is extracted from the subject data, the validity determination unit 123 determines that it is not valid to register in the distributed ledger, the block data that includes the data corresponding to the subject data.

The determination result transmission unit 124 transmits to the validation consensus formation unit 110, data indicating a result of determining the validity.

The contradictory data extraction unit 130 includes an extraction request reception unit 131, a contradictory data selection unit 132, and an extraction result transmission unit 133. The contradictory data extraction unit 130 extracts from the subject data, data that does not follow the form information, as the contradictory data. The contradictory data extraction unit 130 may extract data corresponding to the contradictory data and indicating the form information, as deviation data. When the form information is the state transition information, the contradictory data extraction unit 130 may extract data indicating a state indicated in the state transition information, as the deviation data.

The extraction request reception unit 131 receives an extraction request from the validity determination unit 120.

The contradictory data selection unit 132 extracts the contradictory data based on the out-of-distributed ledger data and data relating to the out-of-distributed ledger data recorded in the ledger data recording unit 140. The contradictory data selection unit 132 extracts a state of data from each of the out-of-distributed ledger data and the data relating to the out-of-distributed ledger data that is present in the ledger data recording unit 140, and checks whether or not there is any state deviation such as missing or duplication on the state of the out-of-distributed ledger data, based on the state transition defined in advance. When the state deviation occurs, the contradictory data selection unit 132 extracts data in which the state deviation occurs, as the contradictor data. The state transition defined in advance is a state transition to be followed by the out-of-distributed ledger data, and is a state transition to be followed by the out-of-distributed ledger data and related data when the ledger data recording unit 140 records the related data relating to the out-of-distributed ledger data.

The extraction result transmission unit 133 transmits a contradictory data extraction result to the validity determination unit 120.

The ledger data recording unit 140 registers data requested to be registered in the ledger data recording unit 140 by the validation consensus formation unit 110, and transmits data requested by the contradictory data extraction unit 130. The ledger data recording unit 140 is also a state Database (DB). Further, the ledger data recording unit 140 is also called a distributed ledger data recording unit.

The client application 300 includes the registration request unit 310, the out-of-ledger data recording unit 320 and the data validation request unit 330.

The registration request unit 310 requests the validation consensus formation unit 110 to register each processing of the validity determination unit 120 and the contradictory data extraction unit 130. Further, the registration request unit 310 is also called a determination extraction process registration request unit.

The out-of-ledger data recording unit 320 records out-of-distributed ledger data. Further, the out-of-ledger data recording unit 320 is also called an out-of-distributed ledger data recording unit. The out-of-ledger data recording unit 320 transmits data to the data validation request unit 330.

The data validation request unit 330 includes a data acquisition unit 331 and a validation request unit 332, and requests the validation consensus formation unit 110 to validate the validity of the data acquired from the out-of-ledger data recording unit 320. The data validation request unit 330 is also called an out-of-distributed ledger data validation request unit.

The data acquisition unit 331 acquires data from the out-of-ledger data recording unit 320.

The validation request unit 332 request the validation consensus formation unit 110 to validate the validity of the acquired out-of-distributed ledger data.

Each of the validity determination unit 120 and the contradictory data extraction unit 130 is implemented by a program that operates on the distributed ledger server 10. The distributed ledger server 10 may implement each of the validity determination unit 120 and the contradictory data extraction unit 130, using a program received from the registration request unit 310. As a specific example, when the distributed ledger is a blockchain, each of the validity determination unit 120 and the contradictory data extraction unit 130 is implemented by a smart contract which is a program that operates on the blockchain when a preset condition is met. The smart contract is registered in the blockchain when a certain number of agreements are reached between blockchain servers connected to the same blockchain network.

***Description of Operation***

An operational procedure of the data validation device 100 is equivalent to a data validation method. Further, a program that implements operation of the data validation device 100 is equivalent to the data validation program.

Operation relating to the validation request transaction 501 will be described.

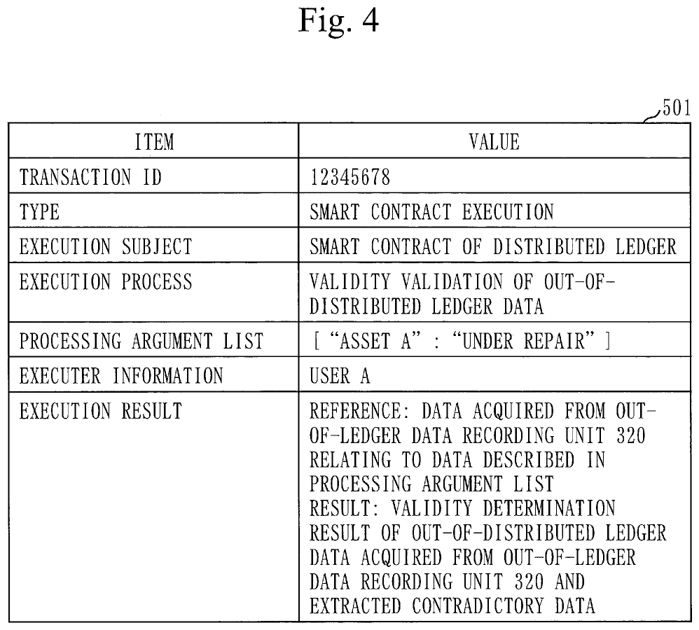

FIG. 4 illustrates an example of the validation request transaction 501.

“Transaction Identification (ID)” is an identifier uniquely representing a transaction that requests the distributed ledger server 10 to process.

“Type” represents a type of a process executed when the distributed ledger server 10 receives the validation request transaction 501. The value of the “type” is data indicating, as a specific example, “distributed ledger built-in function execution”, “smart contract execution”, “smart contract deployment”, or “smart contract update”.

“Execution subject” indicates a name of a process executed by the transaction indicated in the “transaction ID”. The “execution subject” may include information indicating a place where the process is defined. The place is, as a specific example, a place where a distributed ledger built-in function is stored or a place where the smart contract is defined, which is a logic that operates on the blockchain.

“Execution process” indicates the process executed by the transaction indicated in the “transaction ID”. The value of the “execution process” is data indicating, as a specific example, a distributed ledger built-in function, deployment or update of a smart contract, or a process defined in the smart contract. When the value of the “execution process” is a value relating to the smart contract, it is assumed that the name of the smart contract to be deployed or updated is set to the value of the “execution subject”.

“Processing argument list” indicates an argument used in the process indicated in the “execution process”, and is a list indicating a data group that is necessary for the process indicated in the “execution process”. The value of the “processing argument list” includes data indicating out-of-distributed ledger data which is subject to validate validity.

“Executer information” indicates information on an executer of the transaction indicated in the “transaction ID”.

“Execution result” indicates an execution result of a transaction when the process indicated in the “execution subject” is executed using the argument indicated in the “processing argument list”. Further, the “execution result” consists of two types which are reference information and result information. The reference information is information indicating data referenced when executing a transaction. The result information is information indicating output of the process indicated in the “execution process”. Data on the distributed ledger server 10 is stored in the ledger data recording unit 140. The reference information indicates a primary key of all of state DBs referenced during the execution of the process.

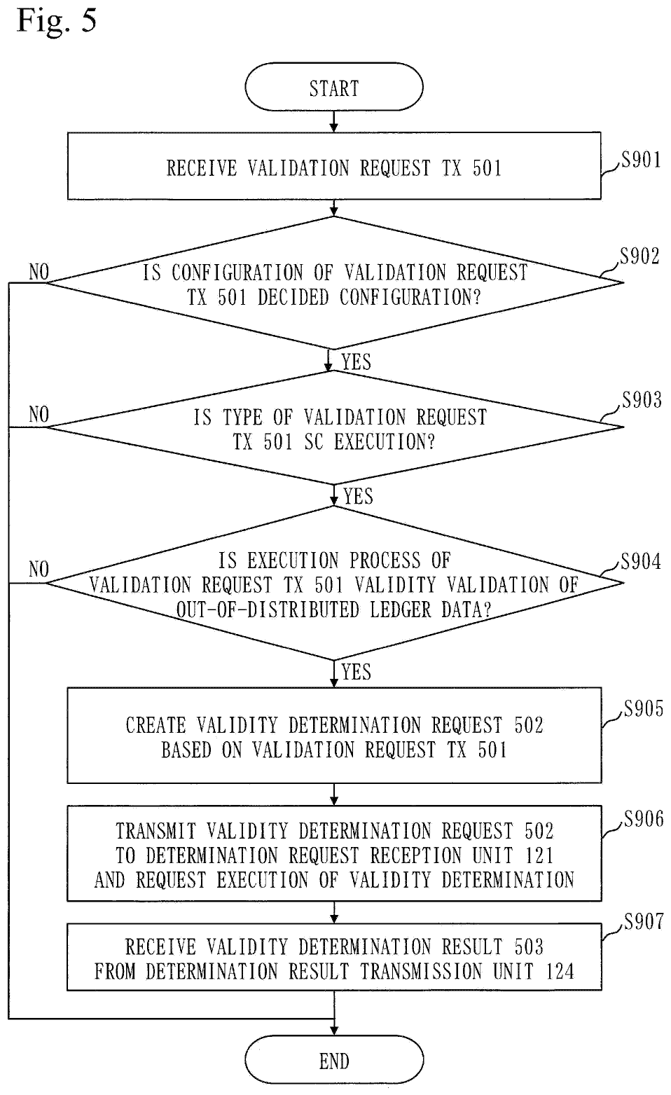

FIG. 5 is a flowchart illustrating an example of the operation relating to the validation request transaction 501 of the validation consensus formation unit 110. This operation will be described with reference to this drawing. Here, TX is an abbreviation for a transaction and SC is an abbreviation for a smart contract.

(Step S901)

The validation request unit 332 transmits the validation request transaction 501 to the request reception unit 111.

The request reception unit 111 receives the validation request transaction 501. The request selection unit 112 transfers the received validation request transaction 501 to the determination request unit 113.

(Step S902)

The determination request unit 113 checks whether or not a configuration of the received validation request transaction 501 is a decided configuration. FIG. 4 illustrates an example of the validation request transaction 501 that follows the decided configuration. As a specific example, the determination request unit 113 checks whether or not the validation request transaction 501 has the items and values indicated in FIG. 4.

When the received validation request transaction 501 is the decided configuration, the validation consensus formation unit 110 transitions to step S903. Otherwise, the validation consensus formation unit 110 ends the process of this flowchart.

(Step S903)

The determination request unit 113 checks whether or not “type” of the received validation request transaction 501 indicates a process that operates on the blockchain. “Smart contract execution” is a specific example of the process that operates on the blockchain.

When the “type” indicates the process that operates on the blockchain, the validation consensus formation unit 110 transitions to step S904. Otherwise, the validation consensus formation unit 110 ends the process of this flowchart.

(Step S904)

The determination request unit 113 checks whether or not the value of “execution process” of the received validation request transaction 501 indicates “validity validation of out-of-distributed ledger data”.

When the value of the “execution process” indicates the “validity validation of out-of-distributed ledger data”, the validation consensus formation unit 110 transitions to step S905. Otherwise, the validation consensus formation unit 110 ends the process of this flowchart.

(Step S905)

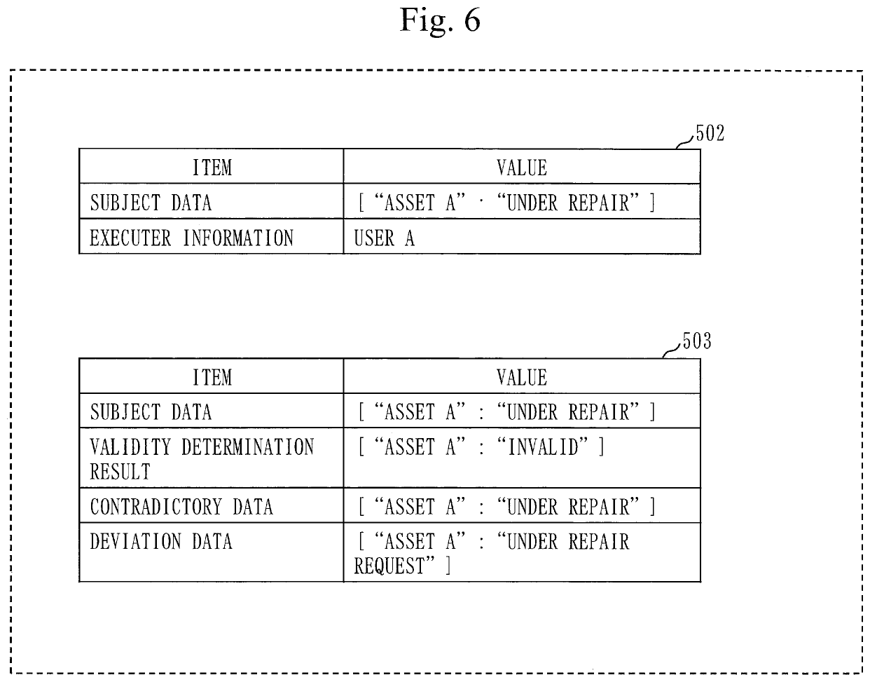

The determination request unit 113 extracts a part of data from the validation request transaction 501, and creates a validity determination request 502. The term request may refer to data indicating a request. The validity determination request 502 is also called an out-of-distributed ledger data validity determination request. As a specific example, when the configuration of the validity determination request 502 is the configuration indicated in FIG. 6, the determination request unit 113 extracts from the validation request transaction 501, the value of each of “processing argument list” and “executer information”, and creates the validity determination request 502. At this time, the determination request unit 113 regards the “processing argument list” as “subject data”.

(Step S906)

The determination request unit 113 requests the validity determination unit 120 to execute a validity determination process by transmitting the validity determination request 502 to the determination request reception unit 121.

The validation consensus formation unit 110 validates the validity of the out-of-distributed ledger data by calling the validity determination process at this step.

(Step S907)

The validation consensus formation request unit 115 receives a validity determination result 503 from the determination result transmission unit 124. The validity determination result 503 is also called an out-of-distributed ledger data validity determination result. Specifically, the validation consensus formation request unit 115 receives data used while executing the validity determination process, data indicating a result of determining the validity of the out-of-distributed ledger data, data extracted as the contradictory data, and data indicating a state corresponding to the contradictory data, which is a state indicated in a state transition prepared in advance.

FIG. 6 illustrates an example of each of the validity determination request 502 and the validity determination result 503.

The validity determination request 502 will be described.

“Subject data” indicates out-of-distributed ledger data whose validity is subject to validate, and the value of the “subject data” is the same as that of the “processing argument list” of the validation request transaction 501.

“Executer information” is the same data as the “executer information” of the validation request transaction 501. In order to take into consideration that the validity determination unit 120 controls the validity determination process using the “executer information”, the “executer information” is included in the validity determination request 502. The validity determination unit 120 may not control the validity determination process corresponding to the validity determination request 502, using the value of the “executer information.”

The validity determination result 503 will be described.

“Subject data” is the same as the “subject data” of the validity determination request 502. The value of the “subject data” is the same as the value of the “subject data” of the validity determination request 502.

“Validity determination result” indicates a result of determining the validity of the “subject data”.

“Contradictory data” indicates contradictory data extracted by the contradictory data extraction unit 130. The column of the “contradictory data” is also the column of “contradictory data extraction result”. When there is no contradictory data, the value of the “contradictory data” is data that means that there is no contradictory data, such as a blank or a character string indicating “no contradictory data”.

“Deviation data” is data indicating a deviation of a state transition relating to subject data and a deviation with regards to the state transition defined in advance. The value of the “deviation data” is, as a specific example, a value that needs to be indicated in the “contradictory data” and a value indicated in the state transition information. The column of the “deviation data” is also the column of “state deviation data extraction result”.

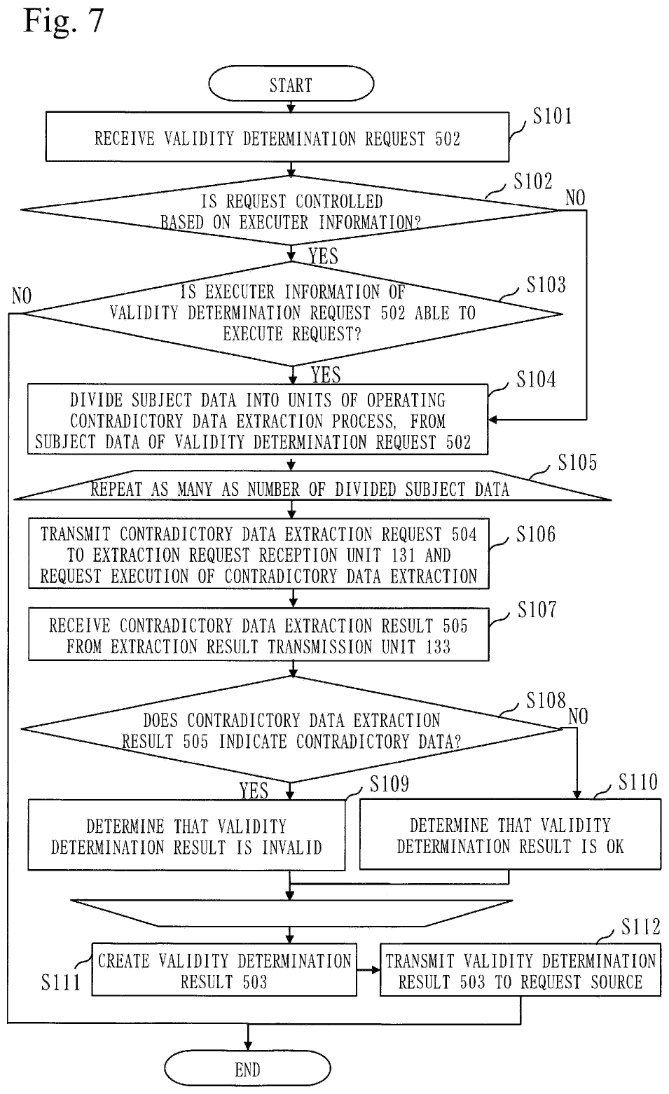

FIG. 7 is a flowchart illustrating an example of operation of the validity determination unit 120. The operation of the validity determination unit 120 will be described with reference to this drawing.

(Step S101)

The determination request reception unit 121 receives the validity determination request 502 from the determination request unit 113.

(Step S102)

The extraction request unit 122 checks whether or not the validity determination process is controlled based on the “executer information” indicated in the validity determination request 502.

When the validity determination process is controlled based on the “executer information”, the validity determination unit 120 transitions to step S103. Otherwise, the validity determination unit 120 transitions to step S104.

(Step S103)

The extraction request unit 122 checks whether or not the validity determination process can be controlled based on the “executer information” indicated in the validity determination request 502.

When the validity determination process can be controlled based on the “executer information”, the validity determination unit 120 transitions to step S104. Otherwise, the validity determination unit 120 ends the process of this flowchart.

(Step S104)

The extraction request unit 122 extracts subject data from the “subject data” indicated in the validity determination request 502 in units of operating a contradictory data extraction process. The “subject data” of the validity determination request 502 may indicate a plurality of pieces of data. When the “subject data” indicates the plurality of pieces of data, the extraction request unit 122 divides the value of the “subject data” into the units of operating the contradictory data extraction process. A method of dividing the value of the “subject data” is, as a specific example, a method of collecting data with the same key with respect to keys of data included in the value of the “subject data”, and regarding the collected data as the units of operating the contradictory data extraction process. The key is, as a specific example, data indicating “asset A” included in the value of the “subject data” of the validity determination request 502 indicated in FIG. 6.

(Step S105)

The validity determination unit 120 repeatedly executes a loop process from steps S106 to S110 as many times as the number of the subject data divided in step S104.

(Step S106)

The extraction request unit 122 requests the contradictory data extraction unit 130 to execute the contradictory data extraction process by transmitting a contradictory data extraction request 504 to the extraction request reception unit 131. The extraction request unit 122 calls the contradictory data extraction unit 130 in the process of this step, and executes the contradictory data extraction process using the out-of-distributed ledger data and distributed ledger data relating to the out-of-distributed ledger data.

(Step S107)

The validity determination unit 123 receives the contradictory data extraction result 505 from the extraction result transmission unit 133. The term result may refer to data indicating a result. As a specific example, the validity determination unit 123 receives data used while executing the contradictory data extraction process, data indicating a result of executing the contradictory data extraction process, and data indicating a state deviation data extraction result.

(Step S108)

The validity determination unit 123 checks whether or not the contradictory data extraction result 505 indicates contradictory data. As a specific example, the validity determination unit 123 checks whether or not the contradictory data extraction result 505 indicates the contradictory data by checking whether or not the value of “contradictory data” of the contradictory data extraction result 505 is input.

When the contradictory data extraction result 505 indicates the contradictory data, the validity determination unit 120 transitions to step S109. Otherwise, the validity determination unit 120 transitions to step S110.

(Step S109)

The validity determination unit 123 determines that the validity of the out-of-distributed ledger data is invalid, that is, it is impossible to register the out-of-distributed ledger data in the distributed ledger.

(Step S110)

The validity determination unit 123 determines that the validity of the out-of-distributed ledger data is OK, that is, it is possible to register the out-of-distributed ledger data in the distributed ledger.

(Step S111)

The validity determination unit 123 creates the validity determination result 503. Specifically, the validity determination unit 123 creates the validity determination result 503 by collecting a validity determination result corresponding to the “subject data” of the validity determination request 502 and “contradictory data” and “deviation data” of the contradictory data extraction result 505 corresponding to the validity determination request 502.

(Step S112)

The determination result transmission unit 124 transmits the validity determination result 503 to a request source. Specifically, the determination result transmission unit 124 transmits the validity determination result 503 to the validation consensus formation request unit 115.

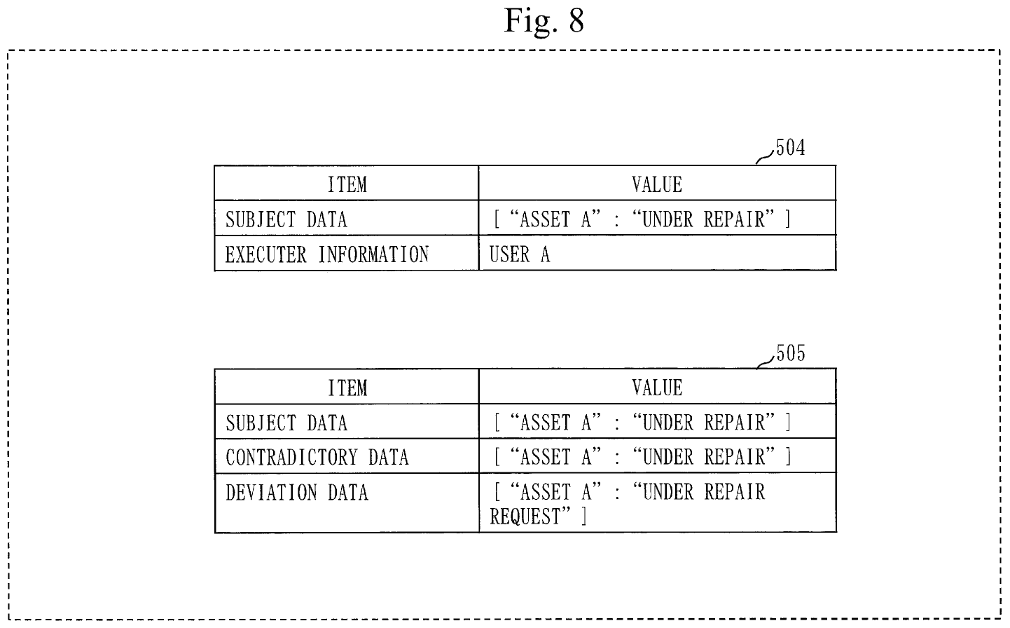

FIG. 8 illustrates an example of each of the contradictory data extraction request 504 and the contradictory data extraction result 505.

The contradictory data extraction request 504 will be described.

“Subject data” is the same as the “subject data” of the validity determination request 502.

“Executer information” is the same as the “executer information” of the validity determination request 502.

The contradictory data extraction result 505 will be described.

“Subject data” is the same as the “subject data” of the validity determination request 502.

“Contradictory data” is the same as the “contradictory data” of the validity determination result 503.

“Deviation data” is the same as the “deviation data” of the validity determination result 503.

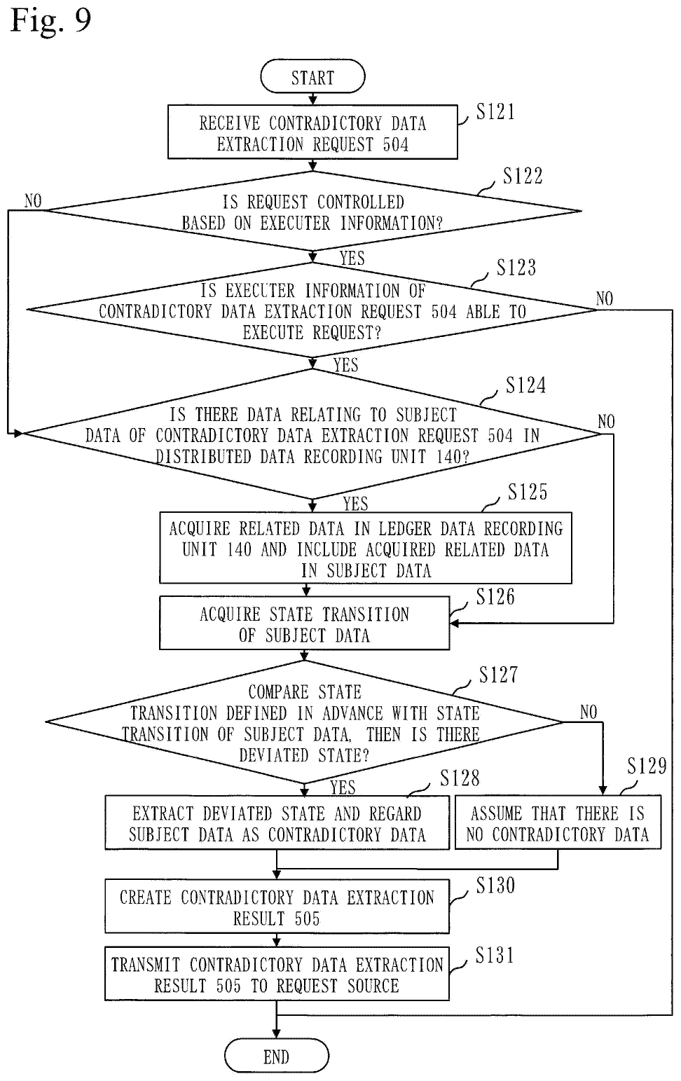

FIG. 9 illustrates a flowchart illustrating operation of the contradictory data extraction unit 130. The operation of the contradictory data extraction unit 130 will be described with reference to this drawing.

(Step S121)

The extraction request reception unit 131 receives the contradictory data extraction request 504 from the extraction request unit 122.

(Step S122)

The contradictory data selection unit 132 checks whether or not the contradictory data extraction process is controlled based on the “executer information” of the contradictory data extraction request 504.

When the contradictory data extraction process is controlled based on the “executer information” of the contradictory data extraction request 504, the contradictory data extraction unit 130 transitions to step S123. Otherwise, the contradictory data extraction unit 130 transitions to step S124.

(Step S123)

The contradictory data selection unit 132 checks whether or not the contradictory data extraction process is executed based on the “executer information” of the contradictory data extraction request 504. Any method may be used to check whether or not the contradictory data extraction process is executed based on the “executer information” of the contradictory data extraction request 504.

When the contradictory data extraction process can be executed based on the “executer information”, the contradictory data extraction unit 130 transitions to step S124. Otherwise, the contradictory data extraction unit 130 ends the process of this flowchart.

(Step S124)

The contradictory data selection unit 132 checks whether or not the ledger data recording unit 140 records related data. The related data is data relating to the “subject data” of the contradictory data extraction request 504. The related data is, as a specific example, data that includes the same key as a key included in data indicated in the “subject data” of the contradictory data extraction request 504, The key in the contradictory data extraction request 504 is, as a specific example, data indicating “asset A” included in the value of the “subject data”.

When the ledger data recording unit 140 records the related data, the contradictory data extraction unit 130 transitions to step S125. Otherwise, the contradictory data extraction unit 130 transitions to step S126.

(Step S125)

The contradictory data selection unit 132 acquires the related data recorded in the ledger data recording unit 140, and includes the acquired related data in the “subject data”, The reason for executing this process is that it is necessary to extract contradictory data in consideration of not only the “subject data” of the contradictors, data extraction request 504 but also the related data recorded in the ledger data recording unit 140.

(Step S126)

The contradictory data selection unit 132 acquires a state transition of the “subject data”. The reason for acquiring the state transition is to extract contradictory data based on the state transition of the data. As a specific example of a method for the contradictory data selection unit 132 to acquire the state transition, there is a method of arranging states of data in ascending order of data creation dates and times set in the data. The state of data is, as a specific example, “under repair” included in the value of the “subject data” of the contradictory data extraction request 504.

(Step S127)

The contradictory data selection unit 132 checks whether or not there is a deviation in the “subject data” by comparing a state transition defined in advance with the state transition of the “subject data”. The state transition to be compared with the state transition of the “subject data” may be stored in any format and in any device such as the contradictory data extraction unit 130 or the ledger data recording unit 140. Further, as an example of a method of checking whether or not there is a deviation state in subject data, there is a, format technique. The format technique is a technique to formally describe a specification such as system behavior or a data transition, and to validate whether or not a validation subject conforms to the described specification. By using the format technique, the contradictory data selection unit 132 is able to use a state transition flow in which ambiguity has been eliminated in the validation of the “subject data”, and to accurately guarantee the validity of the “subject data” based on mathematical logic.

When there is the deviation in the “subject data”, the contradictory data extraction unit 130 proceeds to step S128. Otherwise, the contradictory data extraction unit 130 proceeds to step S129.

(Step S128)

The contradictory data selection unit 132 treats the “subject data” as contradictory data, and extracts from the “subject data”, deviation data indicating a deviated state.

(Step S129)

The contradictory data selection unit 132 does not treat the “subject data” as the contradictory data, and assumes that there is no contradictory data in the “subject data”.

(Step S130)

The contradictory data selection unit 132 creates the contradictory data extraction result 505. As a specific example, the contradictory data selection unit 132 creates the contradictory data extraction result 505 by collecting “subject data” of the contradictory data extraction request 504, and contradictory data and deviation data corresponding to the “subject data” and related data relating to the “subject data”. The contradictory data extraction result 505 is, as a specific example, data obtained by collecting “subject data”, “contradictory data”, and “deviation data”.

Here, the contradictory data extraction process will be described with reference to a specific example.

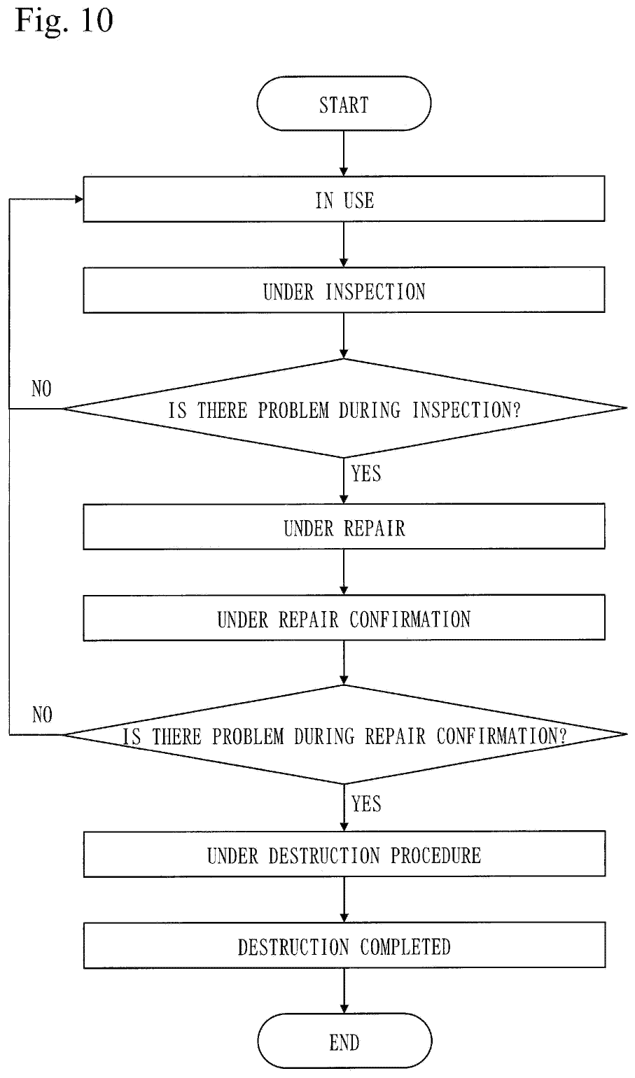

FIG. 10 illustrates a specific example of the state transition flow relating to a life cycle of owned assets. Each wording described in a rectangle of this drawing indicates a name of each state. The contradictory data selection unit 132 checks whether or not, with respect to each owned asset, a state of the owned asset has transitioned according to the state transition flow illustrated in this drawing.

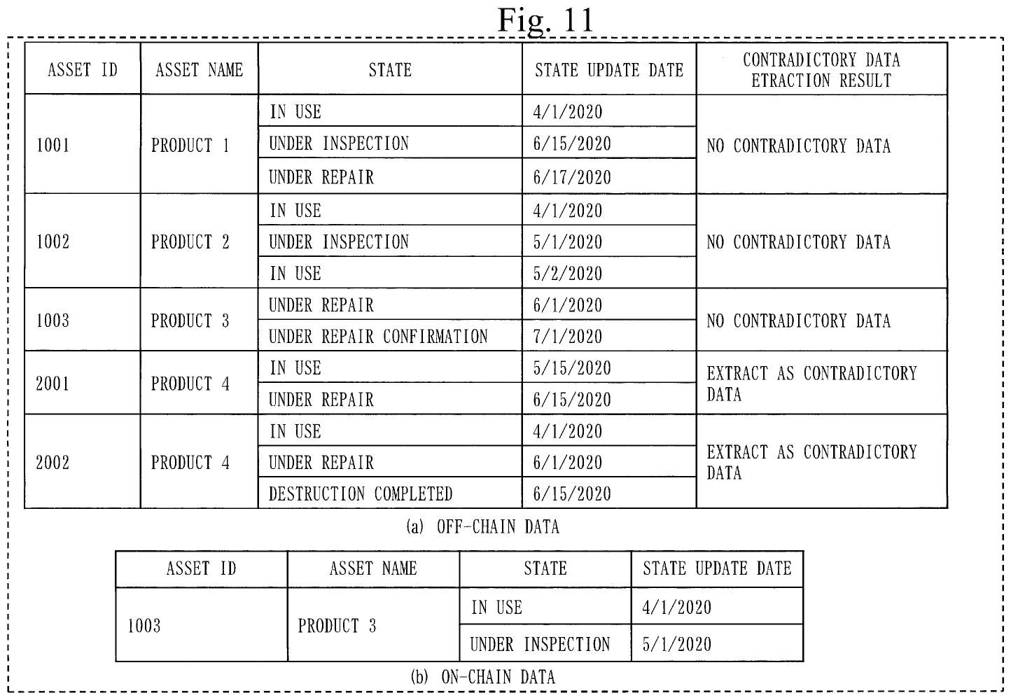

FIG. 11 is a diagram explaining the contradictory data extraction result. FIG. 11 (a) is a table illustrating a specific example of off-chain data and FIG. 11 (b) is a table illustrating a specific example of on-chain data. The off-chain data is out-of-distributed ledger data, and the on-chain data is data registered in a distributed ledger. FIG. 11 (a) illustrates a result of division by the extraction request unit 122 according to an asset ID. Further, the asset ID corresponds to a key.

The contradictory data extraction process will be described below for each asset ID.

<Asset ID 1001>

First, the contradictory data selection unit 132 checks whether or not there is no data whose asset ID is 1001 in the on-chain data. Next, the contradictory data selection unit 132 extracts from the off-chain data, a state transition with respect to the data whose asset ID is 1001, and checks that the extracted state transition follows the state transition flow illustrated in FIG. 10, Accordingly, the contradictory data selection unit 132 does not treat the data whose asset ID is 1001 in the off-chain data as contradictory data. Here, the contradictory data selection unit 132 extracts state transitions by extracting states in order from the oldest corresponding state update date. Further, the state transition extracted by the contradictory data selection unit 132 is a state transition that transitions in order of “in use”, “under inspection”, and “under repair”, and this state transition follows the state transition flow illustrated in FIG. 10. Further, the contradictory data selection unit 132 checks whether or not there is any omission or there is any extra state transition in the extracted state transitions, by comparing the state transition flow illustrated in FIG. 10 with the extracted state transitions.

<Asset ID 1002>

It is the same as the process for the asset ID 1001.

However, the state transition extracted by the contradictory data selection unit 132 is a state transition that transitions in order of “in use”, “under inspection”, and “in use”.

<Asset ID 1003>

First, the contradictory data selection unit 132 checks that there is data whose asset ID is 1003 in the on-chain data. Here, the on-chain data is related data of data whose asset ID is 1003 in the off-chain data, and the contradictory data selection unit 132 includes the on-chain data in the “subject data”. Next, the contradictory data selection unit 132 extracts from the on-chain data and the off-chain data, a state transition with respect to the data whose asset ID is 1003, and checks that the extracted state transition follows the state transition flow illustrated in FIG. 10, Accordingly, the contradictory data selection unit 132 does not treat the data whose asset ID is 1003 in the off-chain data as contradictory data. Here, the state transition extracted by the contradictory data selection unit 132 is a state transition that transitions in order of “in use”, “under inspection” “under repair”, and “under repair confirmation”.

<Asset ID 2001>

A process up to extracting a state transition from the off-chain data is the same as the process for the asset ID 1001.

The state transition extracted by the contradictory data selection unit 132 is a state transition that transitions in order of “in use” and “under repair”. According to the state transition flow illustrated in FIG. 10, the state next to “in use” needs to be “under inspection”, but in the state transition extracted by the contradictory data selection unit 132, the state next to “in use” is “under repair”. Therefore, since the extracted state transition does not follow the state transition flow illustrated in FIG. 10, the contradictory data selection unit 132 extracts data whose asset ID is 2001 in the off-chain data as contradictory data, and extracts as deviation data, data indicating a state transition that transitions in order of “in use”, “under inspection”, and “under repair”.

<Asset ID 2002>

It is the same as the process for the asset ID 2001.

However, a state transition extracted by the contradictory data selection unit 132 is a state transition that transitions in order of “in use”, “under repair”, and “destruction completed”. Further, the contradictory data selection unit 132 extracts as contradictory data, data whose asset ID is 2002 in the off-chain data, and extracts as deviation data, data indicating a state transition that transitions in order of “in use”, “under inspection”, “under repair”, “under repair confirmation”, “under destruction procedure”, and “destruction completed”.

(Step S131)

The extraction result transmission unit 133 transmits the contradictory data extraction result 505 to a request source. Specifically, the extraction result transmission unit 133 transmits to the validity determination unit 123, the contradictory data extraction result 505 created in step S130.

Operation relating to the registration request transaction 506 will be described below.

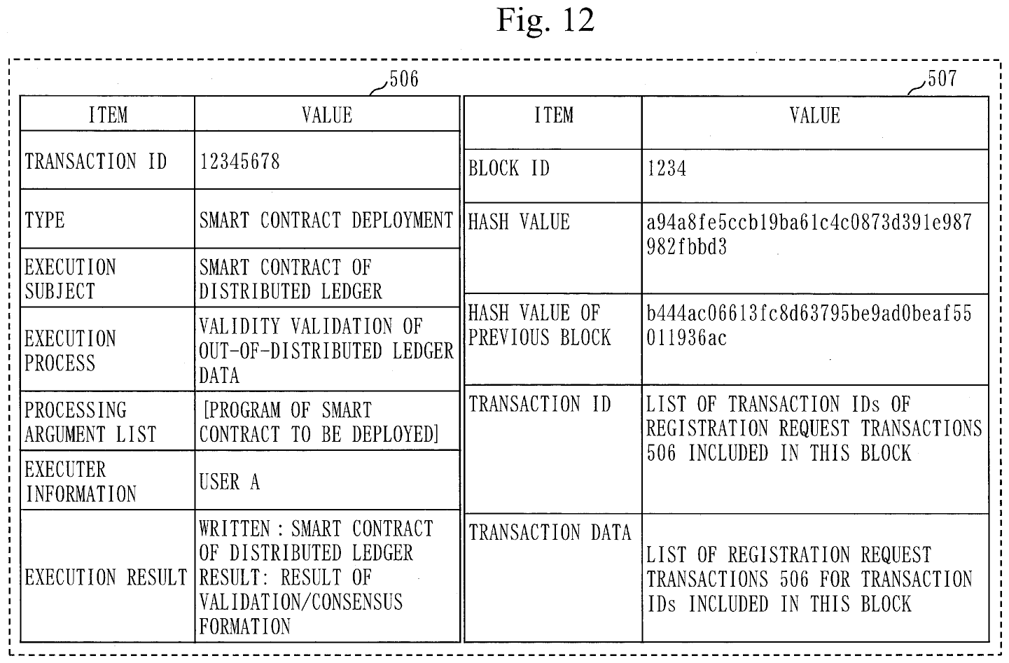

FIG. 12 illustrates each of the registration request transaction 506 and a block 507 that requests validation and consensus formation.

Each item of the registration request transaction 506 is basically the same as each item of the validation request transaction 501.

A program of a smart contract to be deployed or updated is set in the value of “processing argument list”.

“Execution result” consists of two types which are written information and result information. The written information is information indicating written data. The result information includes information indicating success or failure of a smart contract deployment or a configuration of a smart contract, that is, indicating a result of validation and consensus formation.

Each item of the block 507 that requests the validation and the consensus formation will be described.

“Block ID” indicates an identifier uniquely representing a block that requests the distributed ledger server 20 to process.

“Hash value” indicates a hash value used when indicating a connection between blocks.

“Hash value of previous block” indicates a hash value of a previous block which is a block before the block 507 is connected to.

“Transaction ID” indicates a list of transaction IDs indicating the registration request transactions 506 included in the block 507.

“Transaction data” indicates a list of the registration request transactions 506 corresponding to the “transaction ID” of the block 507. The value of the “transaction data” includes all pieces of data of the registration request transactions 506.

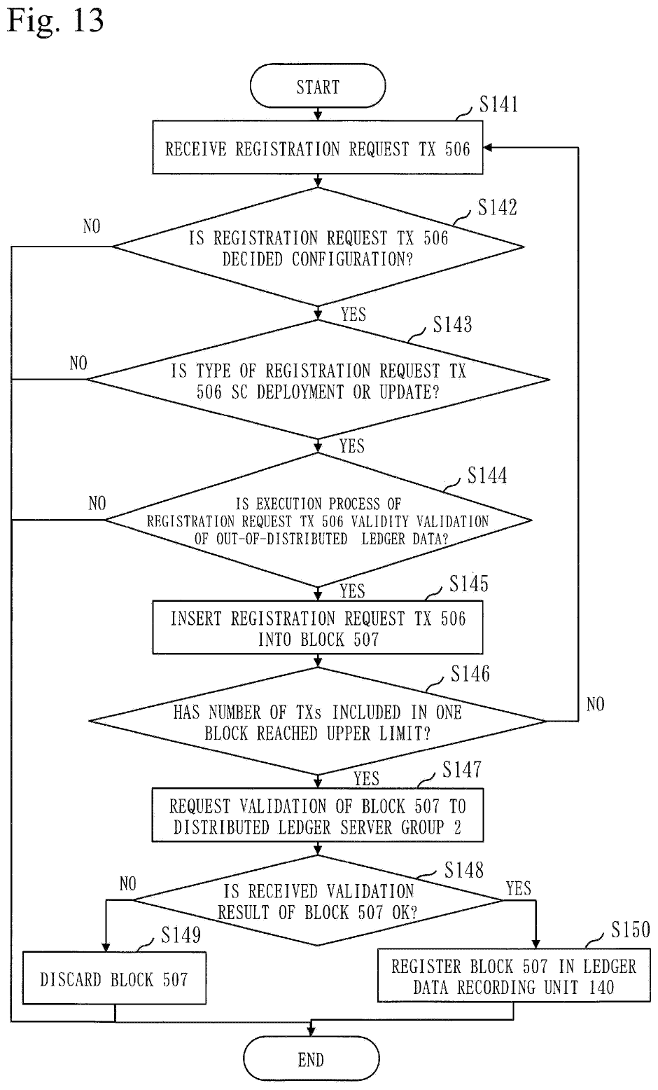

FIG. 13 is a flowchart illustrating an example of the operation relating to the registration request transaction 506 by the validation consensus formation unit 110. The operation will be described with reference to this drawing.

(Step S141)

The registration request unit 310 transmits the registration request transaction 506 to the request reception unit 111.

The request reception unit 111 receives the registration request transaction 506 from the client application 300. The request selection unit 112 transfers the received registration request transaction 506 to the subject data generation unit 114.

(Step S142)

The subject data generation unit 114 checks whether or not a configuration of the received registration request transaction 506 is a decided configuration. FIG. 12 illustrates a specific example of the decided configuration. As a specific example, the subject data generation unit 114 checks whether or not the received registration request transaction 506 has the items and values indicated in FIG. 12.

When the configuration of the received registration request transaction 506 is the decided configuration, the validation consensus formation unit 110 transitions to step S143. Otherwise, the validation consensus formation unit 110 ends the process of this flowchart.

(Step S143)

The subject data generation unit 114 checks whether or not “type” of the received registration request transaction 506 is “smart contract deployment” or “smart contract update”.

When the “type” indicates the “smart contract deployment” or the “smart contract update”, the validation consensus formation unit 110 transitions to step S144. Otherwise, the validation consensus formation unit 110 ends the process of this flowchart.

(Step S144)

The subject data generation unit 114 checks whether or not “execution process” of the registration request transaction 506 indicates “validity validation of out-of-distributed ledger data”.

When the value of the “execution process” indicates the “validity validation of out-of-distributed ledger data”, the validation consensus formation unit 110 transitions to step S145. Otherwise, the validation consensus formation unit 110 ends the process of this flowchart.

(Step S145)

The subject data generation unit 114 inserts the registration request transaction 506 into the block 507. The registration request transaction 506 is equivalent to data corresponding to subject data, A reason for executing this process is to register the data in the ledger data recording unit 140 in units of blocks.

(Step S146)

As a result of executing the process of step S145, the subject data generation unit 114 checks whether or not the lumber of transactions included in the block 507 has reached an upper limit of the number of transactions included in one block. A value of the upper limit depends on such as a type of a distributed ledger to be used.

When the number of transactions included in the block 507 has reached the upper it, the validation consensus formation unit 110 transitions to step S147. Otherwise, since more transactions can be inserted into the block 507, the validation consensus formation unit 110 returns to step S141.

(Step S147)

The validation consensus formation request unit 115 requests each distributed ledger server 20 included in the distributed ledger server group 2 to validate the block 507.

(Step S148)

The result acquisition unit 116 receives a validation result of the block 507 from each distributed ledger server 20, and checks whether or not the received validation result of the block 507 is OK. When requesting the validation from a plurality of distributed ledger servers 20, the result acquisition unit 116 receives a plurality of validation results. In this case, a condition of determining—that the validation result is OK when the validation result received from a distributed ledger server 20 is OK, may be set freely.

When the validation result is not OK, the validation consensus formation unit 110 proceeds to step S149. When the validation result is OK, the validation consensus formation unit 110 proceeds to step S150.

(Step S149)

The data registration request unit 117 discards the block 507.

(Step S150)

The data registration request unit 117 registers the block 507 in the ledger data recording unit 140. By executing this step, the deployment or update of a smart contract included in the registration request transaction 506 completes.

Further, in the description of the operation above, the operation when one data validation device 100 is connected to a ledger network has been described. However, when a plurality of data validation devices 100 are connected to the ledger network, each data validation device 100 may operate similarly in this case, it is assumed that a condition of having the same validity determination unit 120 and the same contradictory data extraction unit 130 between the plurality of data validation devices 100 is satisfied. When the distributed ledger is a blockchain, the condition corresponds to having a smart contract whose processing content is the same between the plurality of data validation devices 100.

Accordingly, on the condition that each of the plurality of data validation devices 100 executes the same processing of the validity determination unit 120 and the same processing of the contradictory data extraction unit 130, each of the plurality of data validation devices 100 is able to execute validity validation of mutually different out-of-distributed ledger data.

### *** Description of Effect of Embodiment 1***

As described above, according to the present embodiment, by the validation consensus formation unit 110, the validity determination unit 120, and the contradictory data extraction unit 130 of the distributed ledger server it is possible to determine the validity of registration on a distributed ledger for data recorded in the out-of-ledger data recording unit 320, based on each of the validation request transaction 501 and the registration request transaction 506 received from the client application 300. Therefore, according to the present embodiment, it is possible to prevent sharing contradictory data with the distributed ledger server 20 connected to the same ledger network.

Here, as a method of taking in out-of-distributed ledger data in a distributed ledger after validating the validity of the out-of-distributed ledger data, there is a sequential method, which is a method of registering in the distributed ledger, pieces of data that are present outside the distributed ledger one by one as one transaction. In the sequential method, since the pieces of data to be registered in the distributed ledger are registered one by one, there is no choice but to validate the pieces of data one by one in the validation of the validity of the pieces of data. Accordingly, the sequential method has a problem in that it is impossible to cope with a case where there is a relation between a plurality of pieces of data and it is necessary to consider the relation between the plurality of pieces of data in the validation of the validity. However, according to the present embodiment, there is no such a problem.

Further, according to the present embodiment, by validating the validity of data to be registered in the distributed ledger in advance for the out-of-distributed ledger data and distributed ledger data relating to the out-of-distributed ledger data, it is possible to prevent sharing incorrect data with a stakeholder.

*** Other Configurations***

<Modification 1>

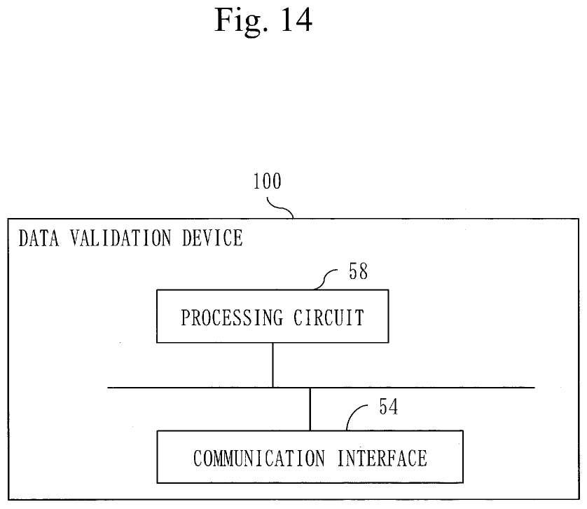

FIG. 14 illustrates a hardware configuration example of the data validation device 100 according to the present modification.

The data validation device 100 includes a processing circuit 58 in place of the processor 51, the processor 51 and the memory 52, the processor 51 and the auxiliary storage device 53, or the processor 51, the memory 52 and the auxiliary storage device 53.

The processing circuit 58 is hardware that implements at least part of the units included in the data validation device 100.

The processing circuit 58 may be dedicated hardware, or may be a processor that executes programs stored in the memory 52.

When the processing circuit 58 is the dedicated hardware, the processing circuit 58 is, as a specific example, a single circuit, a composite circuit, a programmed processor, a parallel-programmed processor, an Application Specific Integrated Circuit (ASIC), a Field Programmable Gate Array (FPGA), or a combination of these.

The data validation device 100 may include a plurality of processing circuits as an alternative to the processing circuit 58. The plurality of processing circuits share the role of the processing circuit 58.

In the data validation device 100, some functions may be implemented by dedicated hardware, and the remaining functions may be implemented by software or firmware.

The processing circuit 58 is implemented by, as a specific example, hardware, software, firmware, or a combination of these.

The processor 51, the memory 52, the auxiliary storage device 53, and the processing circuit 58 are collectively referred to as “processing circuitry”. That is, the functions of the individual functional components of the data validation device 100 are implemented by the processing circuitry.

The other devices may have the same configuration as the present modification.

### Embodiment 2

Differences from the above-described embodiment will be mainly described below with reference to the drawings.

*** Description of Configuration***

In Embodiment 1, the data validation device 100 includes the client application 300 and the distributed ledger server 10. By performing an out-of-distributed ledger data registration request from the client application 300 to the distributed ledger server 10, the data validation device 100 performs the validity determination process and the contradictory data extraction process, and executes validity validation of out-of-distributed ledger data. In the present embodiment, the client application 300 is notified of a validity validation result of the out-of-distributed ledger data. In the description of the present embodiment, differences from Embodiment 1 will be mainly described.

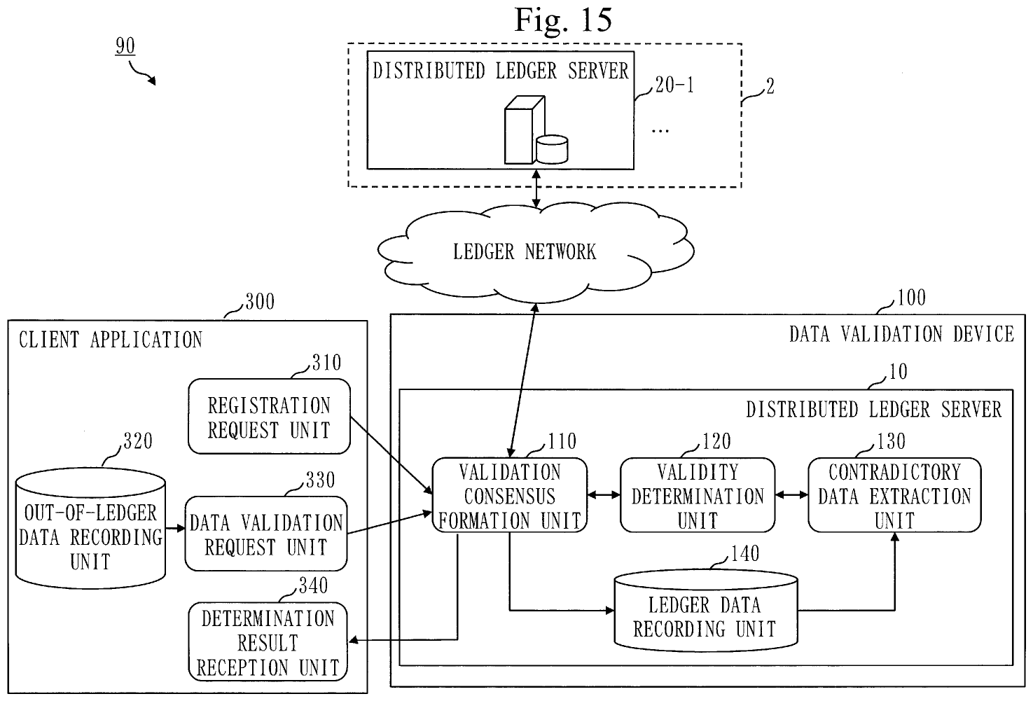

FIG. 15 illustrates a functional configuration example of the data validation system 90 according to the present embodiment.

A difference from Embodiment 1 is that the client application 300 includes a determination result reception unit 340. The determination result reception unit 340 is also called a validity determination result reception unit. With such a configuration, the client application 300 is able to quickly check a validity determination result of the out-of-distributed ledger data.

Further, in the present embodiment a case will be described where communication is directly performed between the validation consensus formation unit 110 and the determination result reception unit 340, but the communication may be performed via some kind of device or means. As a specific example, means that is accessible by both of the validation consensus formation unit 110 and the determination result reception unit 340 is prepared such as a DB, a data store such as a data lake, a message delivery system such as a message queue, or a distributed ledger system, and communication between the validation consensus formation unit 110 and the determination result reception unit 340 may be carried out via the prepared means.

A hardware configuration example according to the present embodiment is the same as the hardware configuration example according to Embodiment 1. Therefore, the description thereof will be omitted.

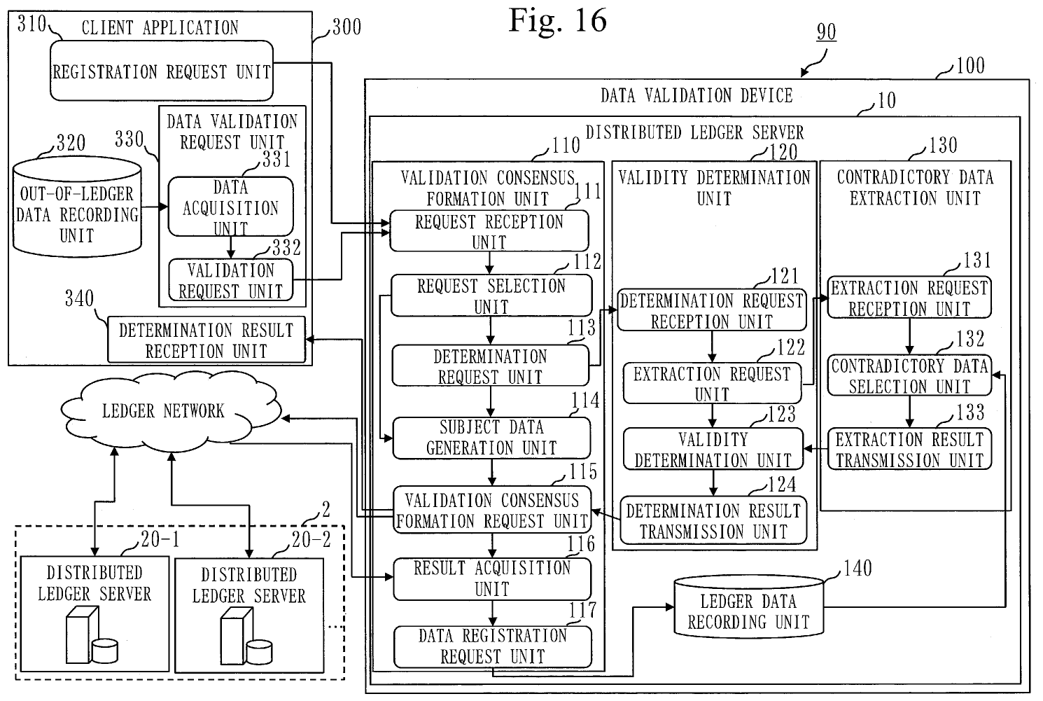

FIG. 16 illustrates a software configuration example of the data validation system 90 according to the present embodiment.

A difference from Embodiment 1 is that the client application 300 includes the determination result reception unit 340.

The determination result reception unit 340 receives from the validation consensus formation request unit 115, a validity determination result for “subject data”, a contradictory data extraction result for the “subject data”, and data indicating such as state deviation data extraction result for the “subject data”. As a result, it is implemented that the client application 300 checks the validity determination result for the out-of-distributed ledger data.

The validation consensus formation request unit 115 transmits to the client application 300 data indicating a result of determining whether or not it is valid to register in a distributed ledger, block data that includes data corresponding to the extracted subject data.

*** Description of Operation***

A procedure up to receiving the validity determination result 503 from the determination result transmission unit 124 is the same as the procedure according to Embodiment 1. Therefore, the description thereof will be omitted.

After receiving the validity determination result 503 from the determination result transmission unit 124, the validation consensus formation request unit 115 creates the validity determination result notification 508 based on the validation request transaction 501 and the validity determination result 503, The term notification may also refer to data to be notified. The validation consensus formation request unit 115 transmits the created validity determination result notification 508 to the determination result reception unit 340.

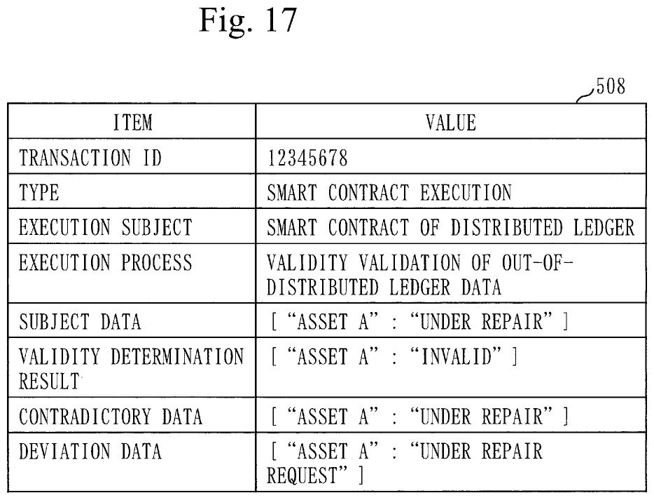

FIG. 17 illustrates an example of the validity determination result notification 508.

“Transaction ID” is the same as the “transaction ID” of the validation request transaction 501.

“Type” is the same as the “type” of the validation request transaction 501.

“Execution subject” is the same as the “execution subject” of the validation request transaction 501.

“Execution process” is the same as the “execution process” of the validation request transaction 501, “Subject data” is the same as the “subject data” of the validity determination result 503.

“Validity determination result” is the same as the “validity determination result” of the validity determination result 503.

“Contradictory data” is the same as the “contradictory data” of the validity determination result 503.

“Deviation data” is the same as the “deviation data” of the validity determination result 503.

The same values as those in the validation request transaction 501 are entered in the “transaction ID”. “type”, “execution subject”, and “execution process” of the validity determination result notification 508. The same values as those in the validity determination result 503 are entered in the “subject data”, “validity determination result”, “contradictory data”, and “deviation data” of the validity determination result notification 508.

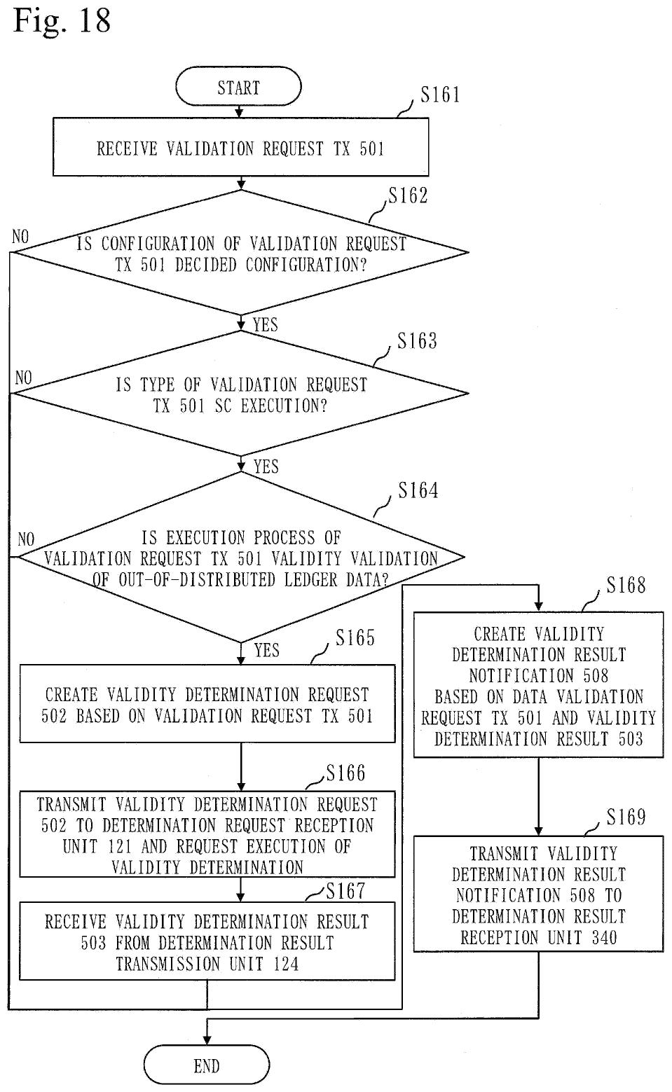

FIG. 18 is a flowchart illustrating an example of processing relating to the validity determination result notification 508 by the validation consensus formation unit 110. The processing will be descried with reference to this drawing.

Steps S161 to S167 are the same as steps S901 to S907. Therefore, the description thereof will be omitted.

(Step S168)

The validation consensus formation request unit 115 creates the validity determination result notification 508 based on the validation request transaction 501 and the validity determination result 503. As a specific example, the validation consensus formation request unit 115, as indicated in the example of the validity determination result notification 508, creates the validity determination result notification 508 by combining the “transaction ID”, “type”, “execution subject”, and “execution process” of the validation request transaction 501 and the “subject data”, “validity determination result”, “contradictory data”, and “deviation data” of the validity determination result 503.

(Step S169)

The validation consensus formation request unit 115 transmits the validity determination result notification 508 to the determination result reception unit 340.

The client application 300 is able to know a validity determination result by checking a content of the validity determination result notification 508 received from the validation consensus formation request unit 115. The client application 300 may present the content of the validity determination result notification 508 to a user.

### *** Description of Effect of Embodiment 2***

As described above, according to the present embodiment, the client application 300 includes the determination result reception unit 340. Therefore, the data validation device 100 is able to notify the determination result reception unit 340 of a validity determination result, and the client application 300 is also able to quickly check the validity determination result.

### Embodiment 3

Differences from the above-described embodiments will be mainly described below with reference to the drawings.

*** Description of Configuration***

The data validation device 100 according to the present embodiment has a function of registering out-of-distributed ledger data in a distributed ledger after replacing contradictory data. The function may be applied to either of Embodiment 1 or Embodiment 2, but for description convenience, a specific example in which the function is applied to Embodiment 1 will be described.

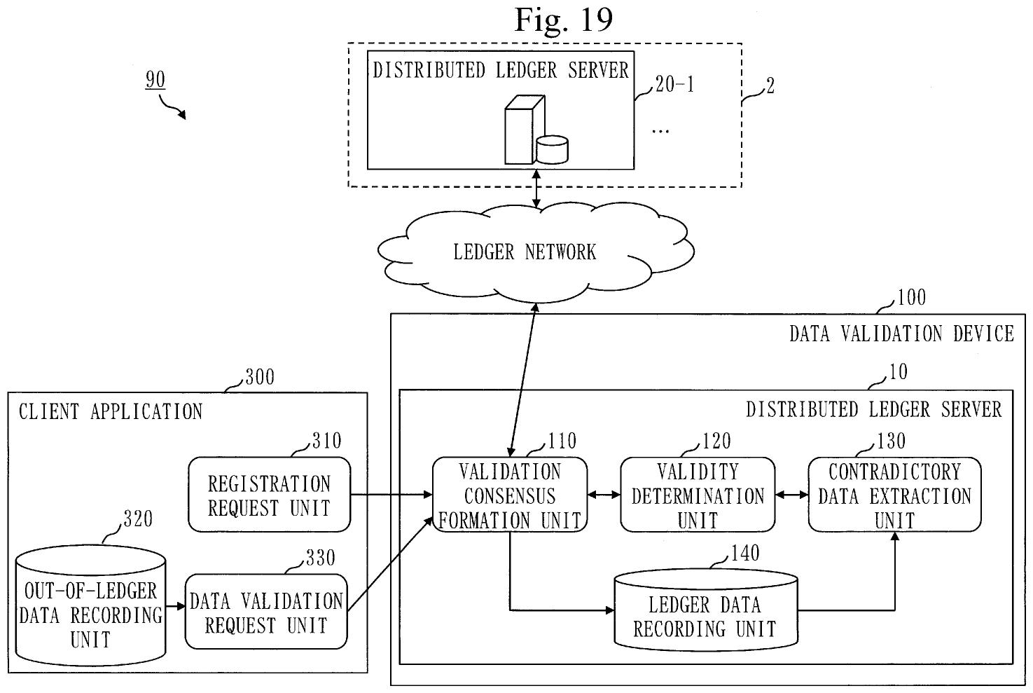

FIG. 19 illustrates a functional configuration example of the data validation system 90 according to the present embodiment. The functional configuration example is the same as the functional configuration example of the data validation system 90 according to Embodiment 1.

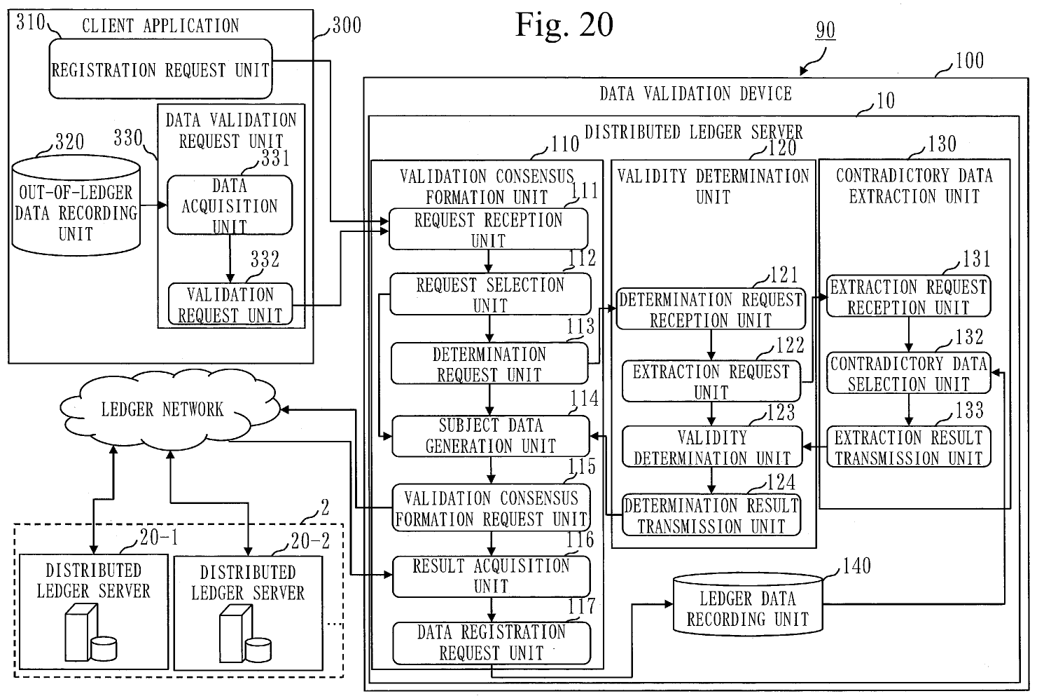

FIG. 20 illustrates a software configuration example of the data validation system 90 according to the present embodiment. A difference from Embodiment 1 is that a destination to which the determination result transmission unit 124 transmits the validity determination result 503 is the subject data generation unit 114.

The subject data generation unit 114 replaces contradictory data included in subject data with deviation data,

*** Description of Operation***

A procedure up to receiving the validity determination result 503 from the determination result transmission unit 124 is the same as the procedure according to Embodiment 1. Therefore, the description thereof will be omitted.

After receiving the validity determination result 503 from the determination result transmission unit 124, the subject data generation unit 114 adds necessary data to “subject data” of a validation request transaction 509 according to a validity determination result, and inserts the validation request transaction 509 including the “subject data” to which the data is added, into the block 510. The validation request transaction 509 is also called an out-of-distributed ledger data validation request transaction. After that, the subject data generation unit 114 checks an upper limit of the number of transactions of the block 510. When the number of transactions of the block 510 has reached the upper limit, the validation consensus formation request unit 115 requests the distributed ledger server 20 to validate the block 510. After the result acquisition unit 116 receives a validation result of the block 510, the data registration request unit 117 registers the block 510 in the ledger data recording unit 140 according to the result.

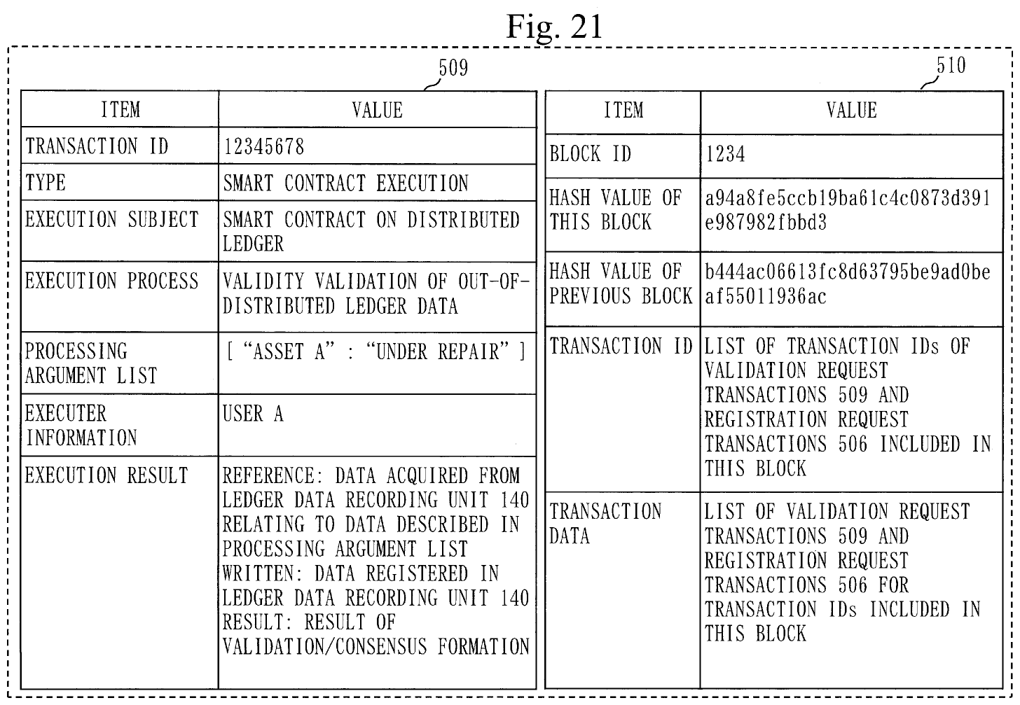

FIG. 21 illustrates an example of each of the validation request transaction 509 and the block 510 that requests validation and consensus formation.

The validation request transaction 509 is basically the same as the validation request transaction 501. A difference of the validation request transaction 509 from the validation request transaction 501 will be described.

“Written” of “execution result” indicates data registered in the ledger data recording unit 140.

“Result” of “execution result” indicates a result of the validation and consensus formation.

The block 510 is basically the same as the block 507. A difference of the block 510 from the block 507 will be described.

“Transaction ID” includes “transaction ID” of the validation request transaction 509 added to the block 510.

“Transaction data” includes data of the validation request transaction 509 added to the block 510.

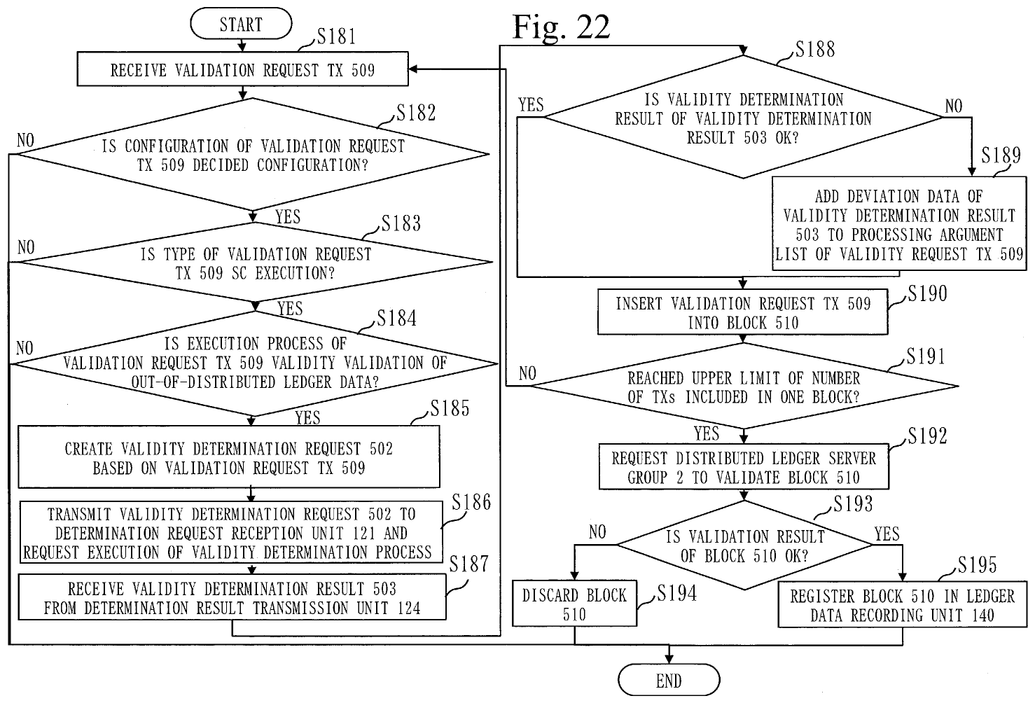

FIG. 22 is flowchart illustrating an example of an out-of-distributed ledger data registration process by the validation consensus formation unit 110. This process will be described with reference to this drawing.

Steps S181 to S187 are the same as steps S901 to S907. Therefore, the description thereof will be omitted.

(Step S188)

The subject data generation unit 114 checks whether or not a validity determination result of the validity determination result 503 indicates OK.

When the validity determination result is OK, there is no contradiction in “subject data” as data to be registered in a distributed ledger, so that the “subject data” may be registered in the distributed ledger as it is. Therefore, the validation consensus formation unit 110 transitions to step S190. Otherwise, the validation consensus formation unit 110 transitions to step S189.

(Step S189)

When the validity determination result does not indicate OK, there is a contradiction in the “subject data” as the data to be registered in the distributed ledger. If the “subject data” is registered in the distributed ledger as it is, contradictory data is shared with the distributed ledger server 20 connected to a ledger network. In order to avoid sharing the contradictory data, data in “processing argument list” of the validation request transaction 509 is replaced with the “deviation data” of the validity determination result 503.

The “deviation data” is data that follows a state transition defined in advance, Therefore, with the process of this step, the data validation device 100 is able to solve a state in which there is a contradiction in the “subject data” as the data to be registered in the distributed ledge.

(Step S190)

The subject data generation unit 114 inserts the validation request transaction 509 into the block 510, The validation request transaction 509 is equivalent to data corresponding to subject data. This step is the same as step S145.

(Step S191)

As a result of executing the process of step S190, the subject data generation unit 114 checks whether or not the number of transactions included in the block 510 has reached an upper limit of the number of transactions included in one block. This step is the same as step S146.

When the number of transactions included in the block 510 has reached the upper limit, the validation consensus formation unit 110 transitions to step S192. Otherwise, the validation consensus formation unit 110 transitions to step S181.

(Step S192)

The validation consensus formation request unit 115 requests each distributed ledger server 20 included in the distributed ledger server group 2 to validate the block 510. This step is the same as step S147.

(Step S193)

The result acquisition unit 116 receives a validation result of the block 510 from each distributed ledger server 20, and checks whether or not the received validation result of the block 510 is OK. This step is the same as step S148.

When the validation result is OK, the validation consensus formation unit 110 proceeds to step S195. Otherwise, the validation consensus formation unit 110 proceeds to step S194.

(Step S194)

The data registration request unit 117 discards the block 510, When the block 510 is discarded, the “subject data” of the validation request transaction 509 is not registered in the ledger data recording unit 140.

(Step S195)

The data registration request unit 117 registers the block 510 in the ledger data recording unit 140. Through the above processes, the data validation device 100 registers the block 510 in the ledger data recording unit 140 while guaranteeing that there is no contradiction in the “subject data” of the validation request transaction 509.

### *** Description of Effect of Embodiment 3***

As described above, according to the present embodiment, by changing a destination to which the determination result transmission unit 124 transmits the validity determination result 503 to the subject data generation unit 114, the subject data generation unit 114 is able to solve contradiction of out-of-distributed ledger data based on a validity determination result and a contradictory data extraction result. As a result, even if the out-of-distributed ledger data includes contradictory data, the out-of-distributed ledger data can be shared with the distributed ledger server 20 after solving the contradiction of the out-of-distributed ledger data.

### ***Other Embodiments***

The above embodiments can be freely combined, or any component of each of the embodiments can be modified. Alternatively, in each of the embodiments, any component can be omitted.

Alternatively, the embodiments are not limited to those presented in Embodiments 1 and 3 and various modifications can be made as needed. The procedures described using the flowcharts or the like may be suitably modified.

### REFERENCE SIGNS LIST

2: distributed ledger server group; 10, 20: distributed ledger server; 100: data validation device; 110: validation consensus formation unit; 111:

request reception unit; 112: request selection unit; 113: determination request unit; 114: subject data generation unit; 115: validation consensus formation request unit; 116: result acquisition unit; 117: data registration request unit; 120: validity determination unit; 121: determination request reception unit; 122:

extraction request unit; 123: validity determination unit; 124: determination result transmission unit; 130: contradictory data extraction unit; 131: extraction request reception unit; 132: contradictory data selection unit; 133: extraction result transmission unit; 140: ledger data recording unit; 300: client application; 310: registration request unit; 320: out-of-ledger data recording unit; 330: data validation request unit; 331: data acquisition unit; 332: validation request unit; 340: determination result reception unit; 51: processor; 52: memory; 53:

auxiliary storage device; 54: communication interface; 58: processing circuit; 90: data validation system; 501: validation request transaction; 502: validity determination request; 503: validity determination result; 504: contradictory data extraction request; 505: contradictory data extraction result; 506: registration request transaction; 507: block; 508: validity determination result notification; 509: validation request transaction; 510: block

1. A data validation device that controls a distributed ledger that records electronic data comprising
processing circuitry to determine whether or not it is valid to register in the distributed ledger, block data that includes data corresponding to subject data, based on form information indicating a form to be followed by data corresponding to the data included in the block data to be registered in the distributed ledger, wherein
the distributed ledger records data relating to the subject data,
the processing circuitry extracts from the subject data, data that does not follow the form information, as contradictory data, based on the subject data and the data relating to the subject data recorded in the distributed ledger, and extracts data corresponding to the contradictory data and indicated in the form information, as deviation data,
the processing circuitry replaces the contradictory data included in the subject data with the deviation data, and
when the contradictory data is extracted from the subject data, the processing circuitry determines that it is not valid to register in the distributed ledger, the block data that includes data corresponding to the subject data.

2. The data validation device according to claim 1, wherein
the processing circuitry divides the subject data into units of extracting the contradictory data.

3. The data validation device according to claim 1, wherein
a value of the deviation data is a value that needs to be indicated in the contradictory data.

4. The data validation device according to claim 1, wherein
the processing circuitry extracts the contradictory data by checking whether or not there is a deviation state in the subject data, using a format technique.

5. The data validation device according to claim 1, wherein
the subject data is at least a part of transaction data.

6. The data validation device according to claim 1, wherein
the processing circuitry receives from a client application, data corresponding to the subject data, and transmits to the client application, data indicating a result of determining whether or not it is valid to register in the distributed ledger, the block data that includes the data corresponding to the subject data.

7. The data validation device according to claim 6 belongs to a ledger network that includes at least one distributed ledger server, wherein
the processing circuitry requests the at least one distributed ledger server to validate the bock data.

8. The data validation device according to claim 1, wherein
the form information is state transition information indicating a state transition.

9. A data validation method that controls a distributed ledger that records electronic data comprising:
determining whether or not it is valid to register in the distributed ledger, block data that includes data corresponding to subject data, based on form information indicating a form to the followed by data corresponding to the data included in the block data to be registered in the distributed ledger, wherein
the distributed ledger records data relating to the subject data;
extracting from the subject data, data that does not follow the form information, as contradictory data, based on the subject data and the data relating to the subject data recorded in the distributed ledger, and extracting data corresponding to the contradictory data and indicated in the form information, as deviation data:
replacing the contradictory data included in the subject data with the deviation data; and
when the contradictory data is extracted from the subject data, determining that it is not valid to register in the distributed ledger, the block data that includes data corresponding to the subject data.

10. A non-transitory computer-readable medium storing a data validation program that controls a distributed ledger that records electronic data, the data validation program causing a data validation device which is a computer to execute
a validity determination process to determine whether or not it is valid to register in the distributed ledger, block data that includes data corresponding to subject data, based on form information indicating a form to be followed by data corresponding to the data included in the block data to be registered in the distributed ledger, wherein
the distributed ledger records data relating to the subject data,
the data validation program further causing the data validation device to execute:
a contradictory data extraction process to extract from the subject data, data that does not follow the form information, as contradictory data, based on the subject data and the data relating to the subject data recorded in the distributed ledger, and to extract data corresponding to the contradictory data and indicated in the form information, as deviation data; and
a subject data generation process to replace the contradictory data included in the subject data with the deviation data, wherein
when the contradictory data is extracted from the subject data, the validity determination process determines that it is not valid to register in the distributed ledger, the block data that includes data corresponding to the subject data.
